(19) United States
(12) Patent Application Publication
(10) Pub. No.: US 2024/0380550 A1
(43) Pub. Date: Nov. 14, 2024

(54) DATA PROCESSING METHOD AND APPARATUS, AND RELATED DEVICE

(71) Applicant: HUAWEI TECHNOLOGIES CO., LTD., Shenzhen (CN)

(72) Inventors: Yuanzhou HU, Shanghai (CN); Lei WANG, Shanghai (CN)

(73) Assignee: HUAWEI TECHNOLOGIES CO., LTD., Shenzhen (CN)

(21) Appl. No.: 18/781,465

(22) Filed: Jul. 23, 2024

Related U.S. Application Data
(63) Continuation of application No. PCT/CN2022/141707, filed on Dec. 24, 2022.

(30) Foreign Application Priority Data
Jan. 25, 2022 (CN) 202210090199.6

(51) Int. Cl. H04L 5/00

(52) U.S. Cl. CPC H04L 5/0051; H04L 5/001

(57) ABSTRACT

A first communication device obtains first data, and maps, based on a mapping relationship between the first data and a time-frequency resource, the first data to the time-frequency resource for transmission. The first data includes at least two differential data symbols or at least two differential spreading data symbols. The mapping relationship includes that two adjacent data units in the first data are adjacent in time domain or frequency domain on the time-frequency resource. The first communication device may flexibly select, based on different scenarios of a time offset or a frequency offset, a mapping relationship between the first data and the time-frequency resource. Based on the mapping relationship, when the time offset or the frequency offset causes a change in frequency domain channels, frequency domain channels through which the two adjacent data units in the first data pass can be close.

### CROSS-REFERENCE TO RELATED APPLICATIONS

This application is a continuation Application No. PCT/CN2022/141707, filed on Dec. 24, 2022, which claims priority to Chinese Patent Application No. 202210090199.6, filed on Jan. 25, 2022. The disclosures of the aforementioned applications are hereby incorporated by reference in their entireties.

### TECHNICAL FIELD

This disclosure relates to the field of communication technologies, and in particular, to a data processing method and apparatus, and a related device.

### BACKGROUND

Currently, orthogonal multiple access (OMA) technology and non-orthogonal multiple access (NOMA) technology attract extensive attention and are widely researched in wireless communication. For example, the OMA technology has been widely applied to a data transmission process in the wireless communication. In OMA technology and NOMA technology, a reference signal may be used for channel estimation to obtain a channel response. A receiving device may perform signal processing such as equalization, demodulation, and decoding by using the channel response, to obtain data sent by a sending device. For non-orthogonal multiple access transmission, to support a large quantity of connected users, the quantity of symbols for sending the reference signal needs to be increased. However, when the quantity of symbols for sending the reference signal is large, overhead of the reference signal is high. In addition, different time offsets (TOs) and different frequency offsets (FOs) may exist in the transmission process. The time offset and/or the frequency offset compromises orthogonality between reference signals sent by different users, and reduces channel estimation performance, in other words, degrades demodulation performance.

### SUMMARY

This disclosure provides a data processing method and apparatus, and a related device. In the data processing method, a reference signal does not need to be sent, thereby avoiding reference signal overhead and a problem of collision between reference signals. In addition, the data processing method provides a plurality of mapping relationships. This helps reduce impact of a time offset and/or frequency offset on a transmission channel, and helps improve demodulation performance.

According to a first aspect, this disclosure provides a data processing method. The data processing method is implemented by a first communication device, or may be performed by a component (such as a processor, a chip, or a chip system) of the first communication device, or may be implemented by a logical module or software that can implement all or some functions of the first communication device. The first communication device obtains first data, and maps, based on a mapping relationship between the first data and a time-frequency resource, the first data to the time-frequency resource for transmission. The first data includes at least two differential data symbols or at least two differential spreading data symbols. The mapping relationship includes that two adjacent data units in the first data are adjacent in time domain or frequency domain on the time-frequency resource. The data unit is any one of the following: the differential data symbol, the differential spreading data symbol, and a differential spreading data symbol block (also referred to as a spreading block).

According to the method, the first data may be sent on a plurality of symbols. In comparison with sending the first data on one symbol, the first communication device may flexibly select, based on different scenarios of a time offset or a frequency offset, a mapping relationship between the first data and the time-frequency resource. Based on the mapping relationship, when the time offset or the frequency offset causes a change in frequency domain channels, in this disclosure, frequency domain channels through which the two adjacent data units in the first data pass can be close. This helps improve demodulation performance.

In a possible implementation, the data unit is the differential data symbol or the differential spreading data symbol. The time-frequency resource includes/symbols and K subcarriers. The mapping relationship includes: The first data is mapped along the L symbols in a first direction on the 2k^{th} subcarrier, and is mapped along the L symbols in a second direction on the (2p+1)^{th} subcarrier based on the data unit. Alternatively, the mapping relationship includes: The first data is mapped along the K subcarriers in a first direction on the 2l^{th} symbol, and is mapped along the K subcarriers in a second direction on the (2q+1)^{th} symbol based on the data unit. The first direction is opposite to the second direction. k is an integer that satisfies 0≤2k≤K−1, p is an integer that satisfies 0≤2p+1≤K−1, l is an integer that satisfies 0≤2l≤ L−1, and q is an integer that satisfies 0≤2q+1≤ L−1. L and K are integers greater than 1.

According to the method, the first communication device may flexibly select, based on the different scenarios of the time offset or the frequency offset, different mapping relationships for the differential data symbol or the differential spreading data symbol. On one hand when the two adjacent data units in the first data are adjacent in time domain on the time-frequency resource, the mapping relationship is used, so that frequency domain channels through which the two adjacent data units in the first data pass can be the closest. In addition, when the time offset causes a change in frequency domain channels of different subcarriers, the frequency domain channels through which the two adjacent data units in the first data pass are still close. This helps improve the demodulation performance. On the other hand, when the two adjacent data units in the first data are adjacent in frequency domain on the time-frequency resource, the mapping relationship is used, so that frequency domain channels through which the two adjacent data units in the first data pass can be the closest. In addition, when the frequency offset causes a change in frequency domain channels of different symbols, the frequency domain channels through which the two adjacent data units in the first data pass are still close. This helps improve the demodulation performance.

In a possible implementation, the data unit is the differential spreading data symbol block. The differential spreading data symbol block includes l_{block}×k_{block} differential spreading data symbols. The time-frequency resource includes L symbols and K subcarriers. The mapping relationship includes: The first data is mapped along the L symbols in a first direction between the 2k×k_{block}^{th} subcarrier and the ((2k+1)k_{block}−1)^{th} subcarrier, and is mapped along the L symbols in a second direction between the (2p+1)k_{block}^{th} subcarrier and the (2(p+1)k_{block}−1)^{th} subcarrier based on the data unit. Alternatively, the mapping relationship includes: The first data is mapped along the K subcarriers in a first direction between the 2l×l_{block}^{th} symbol and the ((2l+1)l_{block}−1)^{th} symbol, and is mapped along the K subcarriers in a second direction between the (2q+1)l_{block}^{th} symbol and the (2(q+1)l_{block}−1)^{th} symbol based on the data unit. The first direction is opposite to the second direction. k is an integer that satisfies 0≤ (2k+1)k_{block}−1≤K−1, p is an integer that satisfies 0≤2 (p+1)k_{block}−1≤K−1, l is an integer that satisfies 0≤ (2l+1)l_{block}−1≤L−1, q is an integer that satisfies 0≤2 (q+1)l_{block}−1≤L−1, block is an integer that satisfies 1≤l_{block}≤L, and k_{block} is an integer that satisfies 1≤k_{block}≤K. L and K are integers greater than 1.

According to the method, the first communication device may flexibly select, based on the different scenarios of the time offset or the frequency offset, different mapping relationships for the differential spreading data symbol block. It should be noted that, in this disclosure, the differential spreading data symbol block is mapped as a whole. On one hand When the two adjacent data units in the first data are adjacent in time domain on the time-frequency resource, the mapping relationship is used, so that frequency domain channels through which the two adjacent data units in the first data pass can be the closest. In addition, when the time offset causes a change in frequency domain channels of different subcarriers, the frequency domain channels through which the two adjacent data units in the first data pass are still close. This helps improve the demodulation performance. On the other hand, when the two adjacent data units in the first data are adjacent in frequency domain on the time-frequency resource, the mapping relationship is used, so that frequency domain channels through which the two adjacent data units in the first data pass can be the closest. In addition, when the frequency offset causes a change in frequency domain channels of different symbols, the frequency domain channels through which the two adjacent data units in the first data pass are still close. This helps improve the demodulation performance.

In a possible implementation, the first communication device outputs an initial value of the first data, where the initial value of the first data is data predefined by the first communication device. Alternatively, when the first data is mapped to the time-frequency resource for transmission, an initial value of the first data is transmitted. It may be understood that the initial value of the first data is also referred to as initialized differential data. According to the method, when the first communication device outputs the initial value of the first data, phase ambiguity that occurs on the 0^{th} data unit of modulated data obtained through data demodulation (including dedifferentiation or despreading) performed by a second communication device can be avoided. This helps improve the demodulation performance.

In a possible implementation, the first communication device maps the first data to the time-frequency resource, and generates data of an orthogonal frequency division multiplexing symbol based on data on the time-frequency resource. The first communication device sends the data of the orthogonal frequency division multiplexing symbol to the second communication device. According to the method, when mapping the first data to the time-frequency resource for transmission, the first communication device may generate the orthogonal frequency division multiplexing (OFDM) symbol for transmission.

In a possible implementation, the first communication device maps the first data to the time-frequency resource, and performs Fourier transform to obtain corresponding Fourier transform output data. The first communication device generates data of a single carrier frequency division multiple access symbol based on the Fourier transform output data. The first communication device sends the data of the single carrier frequency division multiple access (SC-FDMA) symbol to the second communication device. According to the method, when mapping the first data to the time-frequency resource for transmission, the first communication device may generate the SC-FDMA symbol for transmission.

In a possible implementation, the first data comprises differential data symbols generated by using a Pi/2 binary phase shift keying (Pi/2-BPSK) modulation scheme, and a phase difference between two adjacent differential data symbols is π/2 or −π/2. According to the method, the first data generated through differential modulation performed by using the Pi/2-BPSK modulation scheme in this disclosure is still Pi/2-BPSK modulated data. In this way, a peak to average power ratio (PAPR) of data of an OFDM/SC-FDMA symbol generated based on the first data remains unchanged, and the data still features a low PAPR. This helps demodulate the data.

In a possible implementation, a phase difference between any two modulated symbols is π or 0, and the differential data symbol is obtained based on differential modulation of the modulated symbol. According to the method, in comparison with a conventional modulated symbol, a phase difference of modulated symbols generated through modulation performed by using the Pi/2-BPSK modulation scheme is more convenient for calculation.

In a possible implementation, the modulated symbol is obtained by modulating to-be-sent bit data according to the Pi/2-BPSK modulation scheme. A relationship between the to-be-sent bit data and the modulated symbol satisfies:

$$d ( m ) = 1 - 2 b ( m )$$

b(m) represents the m^{th} piece of to-be-sent bit data in at least two pieces of to-be-sent bit data, and d(m) represents the m^{th} modulated symbol in at least two modulated symbols.

A relationship between the modulated symbol and the differential data symbol satisfies:

$$x ( m ) = {e}^{j \frac{π ( m mo d 2 )}{2}} x ( m - 1 ) * d ( m )$$

x(m) represents the m^{th} differential data symbol in at least two differential data symbols, x(m−1) represents the (m−1)^{th} differential data symbol in the at least two differential data symbols, and d(m) represents the m^{th} modulated symbol in the at least two modulated symbols. x(−1) may be referred to as initialized differential data. An initial value of the first data is the initialized differential data.

According to the method, a conventional Pi/2-BPSK modulation scheme is improved, so that the first data generated through differential modulation performed by using the Pi/2-BPSK modulation scheme in this disclosure is still Pi/2-BPSK modulated data. In this way, a PAPR of data of an OFDM/SC-FDMA symbol generated based on the first data remains unchanged, and the data still features a low PAPR. This helps demodulate the data.

In a possible implementation, the modulated symbol is obtained by modulating to-be-sent bit data according to the Pi/2-BPSK modulation scheme. A relationship between the to-be-sent bit data and the modulated symbol satisfies:

$$d ( m ) = j [ 1 - 2 b ( m ) ]$$

b(m) represents the m^{th} piece of to-be-sent bit data in at least two pieces of to-be-sent bit data, d(m) represents the m^{th} modulated symbol in at least two modulated symbols, and j represents an imaginary symbol.

A relationship between the modulated symbol and the differential data symbol satisfies:

$$x ( m ) = x ( m - 1 ) * d ( m )$$

x(m) represents the m^{th} differential data symbol in at least two differential data symbols, x(m−1) represents the (m−1)^{th} differential data symbol in the at least two differential data symbols, and d(m) represents the m^{th} modulated symbol in the at least two modulated symbols.

According to the method, a conventional Pi/2-BPSK modulation scheme is improved, so that the first data generated through differential modulation performed by using the Pi/2-BPSK modulation scheme is still Pi/2-BPSK modulated data. In this way, a PAPR of data of an OFDM/SC-FDMA symbol generated based on the first data remains unchanged, and the data still features a low PAPR. This helps demodulate the data.

According to a second aspect, this disclosure provides another data processing method. The data processing method is implemented by a second communication device, or may be performed by a component (such as a processor, a chip, or a chip system) of the second communication device, or may be implemented by a logical module or software that can implement all or some functions of the second communication device. The second communication device receives first data on a time-frequency resource, and demodulates the first data based on a mapping relationship. The first data includes at least two differential data symbols or at least two differential spreading data symbols. The mapping relationship includes that two adjacent data units in the first data are adjacent in time domain or frequency domain on the time-frequency resource. The data unit is any one of the following: the differential data symbol, the differential spreading data symbol, and a differential spreading data symbol block.

According to the method, when the first data is mapped to the time-frequency resource for transmission based on the mapping relationship, a change in channels between two adjacent data units during demodulation by the receiver can be reduced. This helps improve demodulation performance of the receiver when the receiver demodulates the first data based on the mapping relationship.

In a possible implementation, the data unit is the differential data symbol or the differential spreading data symbol. The time-frequency resource includes L symbols and K subcarriers. The mapping relationship includes: The first data is mapped along the L symbols in a first direction on the 2k^{th} subcarrier, and is mapped along the L symbols in a second direction on the (2p+1)^{th} subcarrier based on the data unit. Alternatively, the mapping relationship includes: The first data is mapped along the K subcarriers in a first direction on the 2l^{th} symbol, and is mapped along the K subcarriers in a second direction on the (2q+1)^{th} symbol based on the data unit. The first direction is opposite to the second direction. k is an integer that satisfies 0≤2k≤K−1, p is an integer that satisfies 0≤2p+1≤K−1, l is an integer that satisfies 0≤2l≤ L−1, and q is an integer that satisfies 0≤2q+1≤L−1. L and K are integers greater than 1.

In a possible implementation, the data unit is the differential spreading data symbol block. The differential spreading data symbol block includes l_{block}×k_{block} differential spreading data symbols. The time-frequency resource includes L symbols and K subcarriers. The mapping relationship includes: The first data is mapped along the L symbols in a first direction between the 2k×k_{block}^{th} subcarrier and the ((2k+1)k_{block}−1)^{th} subcarrier, and is mapped along the L symbols in a second direction between the (2p+1)k_{block}^{th} subcarrier and the (2(p+1)k_{block}−1)^{th} subcarrier based on the data unit. Alternatively, the mapping relationship includes: The first data is mapped along the K subcarriers in a first direction between the 2l×l_{block}^{th} symbol and the ((2l+1)l_{block}−1)^{th} symbol, and is mapped along the K subcarriers in a second direction between the (2q+1)l_{block}^{th} symbol and the (2(q+1)l_{block}−1)^{th} symbol based on the data unit. The first direction is opposite to the second direction. k is an integer that satisfies 0≤(2k+1)k_{block}−1≤K−1, p is an integer that satisfies 0≤2 (p+1)k_{block}−1≤K−1, 1 is an integer that satisfies 0≤ (2l+1)l_{block}−1≤L−1, q is an integer that satisfies 0≤2 (q+1)l_{block}−1≤L−1, block is an integer that satisfies 1≤l_{block}≤L, and k block is an integer that satisfies 1≤k_{block}≤K. L and K are integers greater than 1.

In a possible implementation, the second communication device obtains an initial value of the first data, where the initial value of the first data is data predefined by a first communication device. Alternatively, when receiving the first data on the time-frequency resource, the second communication device receives an initial value of the first data. According to the method, when the second communication device obtains the initial value of the first data, phase ambiguity that occurs on the 0^{th} data unit of modulated data obtained through data demodulation (including dedifferentiation or despreading) performed by the second communication device can be avoided. This helps improve the demodulation performance of the receiver.

According to a third aspect, this disclosure provides still another data processing method. The data processing method is implemented by a first communication device, or may be performed by a component (such as a processor, a chip, or a chip system) of the first communication device, or may be implemented by a logical module or software that can implement all or some functions of the first communication device. The first communication device obtains first data, and maps, based on a mapping relationship between the first data and a time-frequency resource, the first data to the time-frequency resource for transmission. The first data includes at least two differential data symbols or at least two differential spreading data symbols. The time-frequency resource includes/symbols and K subcarriers. The mapping relationship includes: The first data is mapped along the L symbols in a first direction on the 2k^{th} subcarrier, and is mapped along the L symbols in the first direction on the (2p+1)^{th} subcarrier based on a data unit. Alternatively, the mapping relationship includes: The first data is mapped along the K subcarriers in a first direction on the 2l^{th} symbol, and is mapped along the K subcarriers in the first direction on the (2q+1)^{th} symbol based on a data unit. The data unit is a differential data symbol or a differential spreading data symbol. k is an integer that satisfies 0≤2k≤K−1, p is an integer that satisfies 0≤2p+1≤K−1, l is an integer that satisfies 0≤2l≤ L−1, and q is an integer that satisfies 0≤2q+1≤ L−1. L and K are integers greater than 1.

According to the method, in a scenario in which no time offset or frequency offset exists, the first communication device may map, by using the mapping relationship, two adjacent differential data symbols or differential spreading data symbols in the first data to the time-frequency resource for transmission. The mapping relationship is simple and easier to implement. In addition, in the scenario in which no time offset or frequency offset exists, frequency domain channels that the two adjacent differential data symbols or differential spreading data symbols in the first data pass through can also be close. This helps improve demodulation performance.

According to a fourth aspect, this disclosure provides still another data processing method. The data processing method is implemented by a first communication device, or may be performed by a component (such as a processor, a chip, or a chip system) of the first communication device, or may be implemented by a logical module or software that can implement all or some functions of the first communication device. The first communication device obtains first data, and maps, based on a mapping relationship between the first data and a time-frequency resource, the first data to the time-frequency resource for transmission. The first data includes at least two differential data symbols or at least two differential spreading data symbols. The time-frequency resource includes/symbols and K subcarriers. The mapping relationship includes:

The first data is mapped along the L symbols in a first direction between the 2k×k_{block}^{th} subcarrier and the (2k+1)k_{block}−1)^{th} subcarrier, and is mapped along the L symbols in the first direction between the (2p+1)k_{block}^{th} subcarrier and the (2(p+1)k_{block}−1)^{th} subcarrier based on a data unit. Alternatively,
the first data is mapped along the K subcarriers in a first direction between the 2l×l_{block}^{th} symbol and the ((2l+1)l_{block}−1)^{th} symbol, and is mapped along the K subcarriers in the first direction between the (2q+1)l_{block}^{th} symbol and the (2(q+1)l_{block}−1)^{th} symbol based on a data unit.

The data unit is a differential spreading data symbol block. The differential spreading data symbol block includes l_{block}×k_{block} differential spreading data symbols. k is an integer that satisfies 0≤ (2k+1)k_{block}−1≤K−1, p is an integer that satisfies 0≤2 (p+1)k_{block}−1≤K−1, 7 is an integer that satisfies 0≤ (2l+1)l_{block}−1≤L−1, q is an integer that satisfies 0≤2 (q+1)l_{block}−1≤L−1, block is an integer that satisfies 1≤l_{block}≤L, and k_{block} is an integer that satisfies 1≤k_{block}≤K. L and K are integers greater than 1.

According to the method, in a scenario in which no time offset or frequency offset exists, the first communication device may map, by using the mapping relationship, two adjacent differential spreading data symbol blocks in the first data to the time-frequency resource for transmission. The mapping relationship is simple and easier to implement. In addition, in the scenario in which no time offset or frequency offset exists, frequency domain channels that the two adjacent differential spreading data symbol blocks in the first data pass through can also be close. This helps improve demodulation performance.

According to a fifth aspect, this disclosure provides still another data processing method. The data processing method is implemented by a first communication device, or may be performed by a component (such as a processor, a chip, or a chip system) of the first communication device, or may be implemented by a logical module or software that can implement all or some functions of the first communication device. The first communication device obtains second data, where the second data includes at least two differential data symbols. The second data is differential data symbols generated by using a Pi/2-BPSK modulation scheme, and a phase difference between two adjacent differential data symbols is π/2 or −π/2.

According to the method, the first communication device may generate the differential data symbol by using an improved Pi/2-BPSK modulation scheme. In comparison with that a phase difference between differential data symbols generated by using a conventional Pi/2-BPSK modulation scheme may have two or more different values, a value of the phase difference between the differential data symbols generated in this disclosure is π/2 or −π/2. This helps demodulate the data.

In a possible implementation, the differential data symbol is obtained based on differential modulation of a modulated symbol, and the modulated symbol is obtained by modulating to-be-sent bit data according to the Pi/2-BPSK modulation scheme. A relationship between the to-be-sent bit data and the modulated symbol satisfies:

$$d ( m ) = 1 - 2 b ( m )$$

b(m) represents the m^{th} piece of to-be-sent bit data in at least two pieces of to-be-sent bit data, d(m) represents the m^{th} modulated symbol in at least two modulated symbols. A relationship between the modulated symbol and the differential data symbol satisfies:

$$x ( m ) = {e}^{j \frac{π ( m mo d 2 )}{2}} x ( m - 1 ) * d ( m )$$

x(m) represents the m^{th} differential data symbol in at least two differential data symbols, x(m−1) represents the (m−1)^{th} differential data symbol in the at least two differential data symbols, and d(m) represents the m^{th} modulated symbol in the at least two modulated symbols.

According to the method, a conventional Pi/2-BPSK modulation scheme is improved, so that the first data generated through differential modulation performed by using the Pi/2-BPSK modulation scheme in this disclosure is still Pi/2-BPSK modulated data. In this way, a PAPR of data of an OFDM/SC-FDMA symbol generated based on the first data remains unchanged, and the data still features a low PAPR. This helps demodulate the data.

In a possible implementation, a relationship between the to-be-sent bit data and the modulated symbol satisfies:

$$d ( m ) = j [ 1 - 2 b ( m ) ]$$

b(m) represents the m^{th} piece of to-be-sent bit data in at least two pieces of to-be-sent bit data, d(m) represents the m^{th} modulated symbol in at least two modulated symbols, and j represents an imaginary symbol. A relationship between the modulated symbol and the differential data symbol satisfies:

$$x ( m ) = x ( m - 1 ) * d ( m )$$

x(m) represents the m^{th} differential data symbol in at least two differential data symbols, x(m−1) represents the (m−1)^{th} differential data symbol in the at least two differential data symbols, and d(m) represents the m^{th} modulated symbol in the at least two modulated symbols.

According to the method, a conventional Pi/2-BPSK modulation scheme is improved, so that the first data generated through differential modulation performed by using the Pi/2-BPSK modulation scheme is still Pi/2-BPSK modulated data. In this way, a PAPR of data of an OFDM/SC-FDMA symbol generated based on the first data remains unchanged, and the data still features a low PAPR. This helps demodulate the data.

According to a sixth aspect, this disclosure provides a data processing apparatus. The data processing apparatus includes a transceiver unit and a processing unit. The transceiver unit is configured to obtain first data, where the first data includes at least two differential data symbols or at least two differential spreading data symbols. The processing unit is configured to map, based on a mapping relationship between the first data and a time-frequency resource, the first data to the time-frequency resource for transmission. The mapping relationship includes that two adjacent data units in the first data are adjacent in time domain or frequency domain on the time-frequency resource. The data unit is any one of the following: the differential data symbol, the differential spreading data symbol, and a differential spreading data symbol block.

For some implementations of the first data, the mapping relationship, and the like, refer to corresponding descriptions in the first aspect. Details are not described herein again.

According to a seventh aspect, this disclosure provides another data processing apparatus. The data processing apparatus includes a transceiver unit and a processing unit. The transceiver unit is configured to receive first data on a time-frequency resource, where the first data includes at least two differential data symbols or at least two differential spreading data symbols. The processing unit demodulates the first data based on a mapping relationship. The mapping relationship includes that two adjacent data units in the first data are adjacent in time domain or frequency domain on the time-frequency resource. The data unit is any one of the following: the differential data symbol, the differential spreading data symbol, and a differential spreading data symbol block.

For some implementations of the first data, the mapping relationship, and the like, refer to corresponding descriptions in the second aspect. Details are not described herein again.

According to an eighth aspect, this disclosure provides still another data processing apparatus. The data processing apparatus includes a transceiver unit and a processing unit. The transceiver unit is configured to obtain first data, where the first data includes at least two differential data symbols or at least two differential spreading data symbols. The processing unit is configured to map, based on a mapping relationship between the first data and a time-frequency resource, the first data to the time-frequency resource for transmission. The time-frequency resource includes L symbols and K subcarriers. The mapping relationship includes: The first data is mapped along the/symbols in a first direction on the 2k^{th} subcarrier, and is mapped along the L symbols in the first direction on the (2p+1)^{th} subcarrier based on a data unit. Alternatively, the mapping relationship includes: The first data is mapped along the K subcarriers in a first direction on the 2l^{th} symbol, and is mapped along the K subcarriers in the first direction on the (2q+1)^{th} symbol based on a data unit. The data unit is a differential data symbol or a differential spreading data symbol. k is an integer that satisfies 0≤2k≤K−1, p is an integer that satisfies 0≤2p+1≤K−1, 7 is an integer that satisfies 0≤2l≤ L−1, and q is an integer that satisfies 0≤2q+1≤ L−1. L and K are integers greater than 1.

According to a ninth aspect, this disclosure provides still another data processing apparatus. The data processing apparatus includes a transceiver unit and a processing unit. The transceiver unit is configured to obtain first data, where the first data includes at least two differential data symbols or at least two differential spreading data symbols. The processing unit is configured to map, based on a mapping relationship between the first data and a time-frequency resource, the first data to the time-frequency resource for transmission. The time-frequency resource includes/symbols and K subcarriers. The mapping relationship includes:

The first data is mapped along the L symbols in a first direction between the 2k×k_{block}^{th} subcarrier and the (2k+1)k_{block}−1)^{th} subcarrier, and is mapped along the L symbols in the first direction between the (2p+1)k_{block}^{th} subcarrier and the (2(p+1)k_{block}−1)^{th} subcarrier based on a data unit. Alternatively, the first data is mapped along the K subcarriers in a first direction between the 2l×l_{block}^{th} symbol and the ((2l+1)l_{block}−1)^{th} symbol, and is mapped along the K subcarriers in the first direction between the (2q+1)l_{block}^{th} symbol and the (2(q+1)l_{block}−1)^{th} symbol based on a data unit.

The data unit is a differential spreading data symbol block. The differential spreading data symbol block includes l_{block}×k_{block} differential spreading data symbols. k is an integer that satisfies 0≤ (2k+1)k_{block}−1≤K−1, p is an integer that satisfies 0≤2 (p+1)k_{block}−1≤K−1, l is an integer that satisfies 0≤ (2l+1)l_{block}−1≤L−1, q is an integer that satisfies 0≤2 (q+1)l_{block}−1≤L−1, block is an integer that satisfies 1≤l_{block}≤L, and k_{block} is an integer that satisfies 1≤k_{block}≤K. L and K are integers greater than 1.

According to a tenth aspect, this disclosure provides still another data processing apparatus. The data processing apparatus includes a transceiver unit. The transceiver unit is configured to obtain second data, where the second data includes at least two differential data symbols. The second data is differential data symbols generated by using a Pi/2-BPSK modulation scheme, and a phase difference between two adjacent differential data symbols is π/2 or −π/2.

For some implementations of the differential data symbol, a modulated symbol, and the like, refer to corresponding descriptions in the fifth aspect. Details are not described herein again.

According to an eleventh aspect, this disclosure provides a communication device. The communication device includes one or more processors and a memory. The memory is coupled to the one or more processors, and the memory stores a computer program.

In a possible implementation, when the one or more processors execute the computer program, the communication device performs the following operations:
obtaining first data, where the first data includes at least two differential data symbols or at least two differential spreading data symbols; and
mapping, based on a mapping relationship between the first data and a time-frequency resource, the first data to the time-frequency resource for transmission.

The mapping relationship includes that two adjacent data units in the first data are adjacent in time domain or frequency domain on the time-frequency resource. The data unit is any one of the following: the differential data symbol, the differential spreading data symbol, and a differential spreading data symbol block.

For some implementations of the first data, the mapping relationship, and the like, refer to corresponding descriptions in the first aspect. Details are not described herein again.

In a possible implementation, when the one or more processors execute the computer program, the communication device performs the following operations:
receiving first data on a time-frequency resource; and
demodulating the first data based on a mapping relationship.

The first data includes at least two differential data symbols or at least two differential spreading data symbols. The mapping relationship includes that two adjacent data units in the first data are adjacent in time domain or frequency domain on the time-frequency resource. The data unit is any one of the following: the differential data symbol, the differential spreading data symbol, and a differential spreading data symbol block.

For some implementations of the first data, the mapping relationship, and the like, refer to corresponding descriptions in the second aspect. Details are not described herein again.

In a possible implementation, when the one or more processors execute the computer program, the communication device performs the following operations:
obtaining first data; and
mapping, based on a mapping relationship between the first data and a time-frequency resource, the first data to the time-frequency resource for transmission.

The first data includes at least two differential data symbols or at least two differential spreading data symbols. The time-frequency resource includes L symbols and K subcarriers. The mapping relationship includes: The first data is mapped along the L symbols in a first direction on the 2k^{th} subcarrier, and is mapped along the L symbols in the first direction on the (2p+1)^{th} subcarrier based on a data unit. Alternatively, the mapping relationship includes: The first data is mapped along the K subcarriers in a first direction on the 2l^{th} symbol, and is mapped along the K subcarriers in the first direction on the (2q+1)^{th} symbol based on a data unit. The data unit is a differential data symbol or a differential spreading data symbol. k is an integer that satisfies 0≤2k≤K−1, p is an integer that satisfies 0≤2p+1≤K−1, l is an integer that satisfies 0≤2l≤L−1, and q is an integer that satisfies 0≤2q+1≤ L−1. L and K are integers greater than 1.

In a possible implementation, when the one or more processors execute the computer program, the communication device performs the following operations:
obtaining first data; and mapping, based on a mapping relationship between the first data and a time-frequency resource, the first data to the time-frequency resource for transmission.

The first data includes at least two differential data symbols or at least two differential spreading data symbols. The time-frequency resource includes L symbols and K subcarriers. The mapping relationship includes:

The first data is mapped along the L symbols in a first direction between the 2k×k_{block}^{th} subcarrier and the ((2k+1)k_{block}−1)^{th} subcarrier, and is mapped along the L symbols in the first direction between the (2p+1)k_{block}^{th} subcarrier and the (2(p+1)k_{block}−1)^{th} subcarrier based on a data unit. Alternatively,
the first data is mapped along the K subcarriers in a first direction between the 2l×l_{block}^{th} symbol and the ((2l+1)l_{block}−1)^{th} symbol, and is mapped along the K subcarriers in the first direction between the (2q+1)l_{block}^{th} symbol and the (2(q+1)l_{block}−1)^{th} symbol based on a data unit.

The data unit is a differential spreading data symbol block. The differential spreading data symbol block includes l_{block}×k_{block} differential spreading data symbols. k is an integer that satisfies 0≤ (2k+1)k_{block}−1≤K−1, p is an integer that satisfies 0≤2 (p+1)k_{block}−1≤K−1, l is an integer that satisfies 0≤ (2l+1)l_{block}−1≤L−1, q is an integer that satisfies 0≤2 (q+1)l_{block}−1≤L−1, block is an integer that satisfies 1≤l_{block}≤L, and K_{block} is an integer that satisfies 1≤k_{block}≤K. L and K are integers greater than 1.

In a possible implementation, when the one or more processors execute the computer program, the communication device performs the following operations:
obtaining second data, where the second data includes at least two differential data symbols, the second data is differential data symbols generated by using a Pi/2-BPSK modulation scheme, and a phase difference between two adjacent differential data symbols is π/2 or −π/2.

For some implementations of the differential data symbol, a modulated symbol, and the like, refer to corresponding descriptions in the fifth aspect. Details are not described herein again.

According to a twelfth aspect, this disclosure provides a communication system. The communication system includes one or more of the data processing apparatuses provided in the sixth aspect to the tenth aspect. Alternatively, the communication system includes the communication device provided in the eleventh aspect.

According to a thirteenth aspect, this disclosure provides a chip system. The chip system includes a processor, and may further include a memory, configured to implement the method in any one of the first aspect to the fifth aspect and the possible implementations of the first aspect to the fifth aspect. The chip system may include a chip, or may include the chip and another discrete component.

An interface in the chip may be an input/output interface, a pin, a circuit, or the like.

The chip system may be a system on chip (SoC), a baseband chip, or the like. The baseband chip may include a processor, a channel encoder, a digital signal processor, a modem, an interface module, and the like.

According to a fourteenth aspect, this disclosure provides a communication apparatus. The communication apparatus includes an input/output interface and a logic circuit. The input/output interface is configured to input or output data. The logic circuit processes the data according to the method in any one of the first aspect or the third aspect to the fifth aspect and the possible implementations of the first aspect or the third aspect to the fifth aspect, to obtain processed data.

According to a fifteenth aspect, this disclosure provides a communication apparatus. The communication apparatus includes an input/output interface and a logic circuit. The input/output interface is configured to input or output data. The logic circuit processes the data according to the method in any one of the second aspect and the possible implementations of the second aspect, to obtain processed data.

According to a sixteenth aspect, this disclosure provides a computer-readable storage medium. The computer-readable storage medium stores a computer program. The computer program is executed by a processor to implement the method in any one of the first aspect to the fifth aspect and the possible implementations of the first aspect to the fifth aspect.

According to a seventeenth aspect, this disclosure provides a computer program product. The computer program product includes instructions. When the instructions are run on a computer, the computer is enabled to perform the method in any one of the first aspect to the fifth aspect and the possible implementations of the first aspect to the fifth aspect.

### BRIEF DESCRIPTION OF DRAWINGS

FIG. 1 is a diagram of a communication system according to this disclosure;

FIG. 2 is a diagram of a differential spreading data generation process according to this disclosure;

FIG. 3 is a schematic flowchart of a data processing method according to this disclosure;

FIG. 4a is a diagram of a type of differential spreading data according to this disclosure;

FIG. 4b is a diagram of another type of differential spreading data according to this disclosure;

FIG. 5 is a diagram of a first mapping relationship between differential data and a time-frequency resource according to this disclosure;

FIG. 6 is a diagram of a first mapping relationship between differential spreading data and a time-frequency resource according to this disclosure;

FIG. 7a is a diagram of a mapping manner of a differential spreading data symbol in a spreading block according to this disclosure;

FIG. 7b is a diagram of another mapping manner of a differential spreading data symbol in a spreading block according to this disclosure;

FIG. 8 is a diagram of a second mapping relationship between differential spreading data and a time-frequency resource according to this disclosure;

FIG. 9 is a diagram of a second mapping relationship between differential data and a time-frequency resource according to this disclosure;

FIG. 10 is a diagram of a third mapping relationship between differential spreading data and a time-frequency resource according to this disclosure;

FIG. 11 is a diagram of a fourth mapping relationship between differential spreading data and a time-frequency resource according to this disclosure;

FIG. 12 is a diagram of a third mapping relationship between differential data and a time-frequency resource according to this disclosure;

FIG. 13 is a diagram of a fifth mapping relationship between differential spreading data and a time-frequency resource according to this disclosure;

FIG. 14 is a diagram of a fourth mapping relationship between differential data and a time-frequency resource according to this disclosure;

FIG. 15 is a diagram of a sixth mapping relationship between differential spreading data and a time-frequency resource according to this disclosure;

FIG. 16 is a diagram of a seventh mapping relationship between differential spreading data and a time-frequency resource according to this disclosure;

FIG. 17 is a diagram of an eighth mapping relationship between differential spreading data and a time-frequency resource according to this disclosure;

FIG. 18 is a schematic flowchart of another data processing method according to this disclosure;

FIG. 19 is a diagram of a device according to this disclosure; and

FIG. 20 is a diagram of an apparatus according to this disclosure.

### DESCRIPTION OF EMBODIMENTS

A wireless communication system includes communication devices, and the communication devices may perform wireless communication over an air interface resource. The communication devices may include a network device and a terminal device, and the network device may also be referred to as a network side device. The air interface resource may include at least one of a time domain resource, a frequency domain resource, a code resource, or a spatial resource. In this disclosure, “at least one” may also be described as “one or more”, and “a plurality of” may be two, three, four, or more. This is not limited in this disclosure.

In this disclosure, “/” may represent an “or” relationship between associated objects. For example, A/B may represent A or B. “And/or” may be used to describe three relationships of associated objects. For example, A and/or B may represent the following three cases: Only A exists, both A and B exist, and only B exists, where A and B may be singular or plural. For ease of describing the technical solutions of this disclosure, in this disclosure, the words such as “first” and “second” may be used to distinguish technical features with a same or similar function. The words such as “first” and “second” do not limit a quantity and an execution sequence, and the words such as “first” and “second” do not limit a definite difference. In this disclosure, the word such as “example” or “for example” represents an example, an evidence, or a description. Any embodiment or design solution described as “example” or “for example” should not be explained as being more preferred or having more advantages than another embodiment or design solution. The word such as “example” or “for example” is used to present a related concept in a specific manner for ease of understanding.

The following describes the technical solutions of this disclosure with reference to the accompanying drawings.

Currently, an OMA technology and a NOMA technology attract extensive attention and are widely researched in wireless communication. For example, the OMA technology has been widely applied to a data transmission process in the wireless communication. In the OMA technology and the NOMA technology, data and a reference signal are generally sent. The data and the reference signal may be generated by using technologies such as OFDM and SC-FDMA. The reference signal may be used for channel estimation to obtain a channel response. A receiving device may perform processing such as equalization, demodulation, and decoding by using the channel response, to obtain data sent by a sending device.

On one hand, for non-orthogonal multiple access transmission, to support a large quantity of connected users, a quantity of symbols for sending the reference signal needs to be increased, to improve a capacity of the reference signal. However, when the quantity of symbols for sending the reference signal is large, overhead of the reference signal is high. On the other hand, for different users of the non-orthogonal multiple access transmission, different TOs and different FOs may exist. The time offset and/or the frequency offset compromises orthogonality between reference signals sent by the different users, and reduces channel estimation performance, in other words, degrades demodulation performance.

To resolve the foregoing problems, this disclosure provides a data processing method. In the data processing method, a reference signal does not need to be sent, thereby avoiding reference signal overhead and a problem of collision between reference signals. In addition, in the data processing method, differential modulation and/or spreading processing may be performed on modulated data, and first data obtained through processing supports a plurality of time-frequency resource mapping relationships. This helps improve demodulation performance.

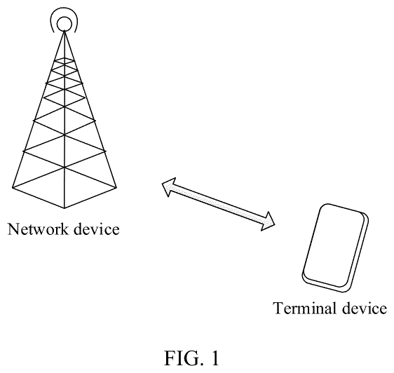

The data processing method provided in this disclosure may be applied to a communication system shown in FIG. 1. The communication system includes a plurality of communication devices (for example, including a network device and a terminal device). In this disclosure, it is assumed that a first communication device is a sending device, and a second communication device is a receiving device. For example, in an uplink transmission scenario, the first communication device may be a terminal device, and the second communication device may be a network device. For another example, in a downlink transmission scenario, the first communication device may be a network device, and the second communication device may be a terminal device. In this disclosure, the uplink transmission scenario is used as an example to describe a procedure of the data processing method. It may be understood that a procedure in the downlink transmission scenario is similar to that in the uplink transmission scenario. For details, refer to descriptions of the procedure in the uplink transmission scenario.

The communication system mentioned in this disclosure includes but is not limited to a narrowband internet of things (NB-IoT) system, a global system for mobile communications (GSM), an enhanced data rate for GSM evolution (EDGE) system, a wideband code division multiple access (WCDMA) system, a code division multiple access 2000 (CDMA2000) system, a time division-synchronous code division multiple access (TD-SCDMA) system, a long term evolution (LTE) system, three disclosure scenarios of a 5G mobile communication system: enhanced mobile broadband (eMBB), ultra-reliable and low-latency communication (URLLC), and enhanced machine type communication (eMTC), and a future communication system (such as 6G/7G).

The network device may be a device that can communicate with the terminal device. The network device may be a base station, a relay station, or an access point. The base station may be a base transceiver station (BTS) in a GSM system or a code division multiple access (CDMA) network, or may be a 3G base station NodeB in a WCDMA system, or may be an evolutional NodeB (eNB or eNodeB) in an LTE system. Alternatively, the network device may be a satellite in a satellite communication system. Alternatively, the network device may be a radio controller in a cloud radio access network (CRAN) scenario. Alternatively, the network device may be a network device in a 5G network or a network device (for example, a gNodeB) in a future evolved public land mobile network (PLMN) network. Alternatively, the network device may be a wearable device, an uncrewed aerial vehicle, a device in internet of vehicles (for example, a vehicle-to-everything (V2X) device), a communication device in device-to-device (D2D) communication, or a network device used in a future communication system.

The terminal device may be user equipment (UE), an access terminal, a terminal unit, a terminal station, a mobile station, a remote station, a remote terminal, a mobile device, a terminal, a wireless communication device, a terminal agent, a terminal apparatus, or the like. The access terminal may be a cellular phone, a cordless phone, a session initiation protocol (SIP) phone, a wireless local loop (WLL) station, personal digital assistant (PDA), a handheld device or a computing device with a wireless communication function, another processing device connected to a wireless modem, a wearable device, an uncrewed aerial vehicle, a V2X device, a D2D device, a terminal device in a 5G network, a terminal device in a future evolved PLMN network, a terminal device in a future communication system, or the like.

For ease of understanding, the following describes definitions of related terms in this disclosure in detail.

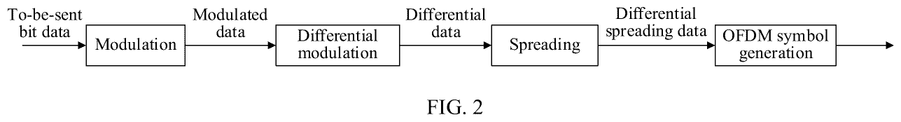

1. Data generation process of a sending device: The sending device may perform differential modulation on modulated data to generate differential data; or the sending device may perform differential modulation and spreading on modulated data to generate differential spreading data. For example, FIG. 2 shows a differential spreading data generation process according to this disclosure. A sending device modulates to-be-sent bit data by using a corresponding modulation scheme to obtain modulated data, performs differential modulation on the modulated data to obtain differential data, and performs spreading processing on the differential data to obtain differential spreading data. The spreading processing is optional. The data generation process of the sending device mainly relates to the following several types of data: to-be-sent bit data, modulated data, differential data, and differential spreading data.

The to-be-sent bit data may be obtained by performing processing such as encoding, interleaving, and scrambling on an original bit stream. The original bit stream may be obtained based on a service to be sent by the sending device. This is not limited in this disclosure. The modulation scheme used in this disclosure may include but is not limited to binary phase shift keying (BPSK) modulation, Pi/2-BPSK modulation, quadrature phase shift keying (QPSK) modulation, octal phase shift keying (8PSK) modulation, and the like.

For example, the modulated data is represented as d, and a length of the modulated data is M, to be specific, the modulated data includes M data units (modulated data symbols). The differential data is represented as x, and a length of the differential data is M. Differential modulation is performed on the modulated data to obtain the differential data, as shown in formula (1).

$$x ( m ) = x ( m - 1 ) d ( m ) \qquad ( 1 )$$

x(m) represents the m^{th} data unit (differential data symbol) of the differential data. d(m) represents the m^{th} data unit (modulated data symbol) of the modulated data. m satisfies 0≤m≤M−1, where M is an integer greater than 1. When m=0, x(0)=x(−1)d(0). x(−1) may be referred to as initialized differential data, namely, an initial value of first data. The initialized differential data may be predefined. For example, a value of the initialized differential data may be predefined as 1. When predefined, the initialized differential data is known to both the sending device and a receiving device. Alternatively, the initialized differential data may be sent by a first communication device to a second communication device. When the initialized differential data is sent, the second communication device knows a location to which the initialized differential data is sent. In this case, the second communication device may receive the initialized differential data at the corresponding location.

It should be noted that in this disclosure, a data unit represents a minimum unit of data or a set of minimum units of the data. For example, the data unit in this disclosure may include but is not limited to a bit data symbol, a modulated data symbol, a differential data symbol, a differential spreading data symbol, a differential spreading data symbol block, and the like. A data unit of the bit data is the bit data symbol, a data unit of the differential data is the differential data symbol, and a data unit of the differential spreading data is the differential spreading data symbol or the differential spreading data symbol block.

2. Generation manner of modulated data: When different modulation schemes are used, a relationship between to-be-sent bit data, modulated data, and differential data separately satisfies different formulas.

For example, when the modulation scheme is BPSK modulation, a relationship between the to-be-sent bit data and the modulated data is shown in formula (2), and a relationship between the modulated data and the differential data is shown in formula (1).

$$d ( m ) = 1 - 2 b ( m ) \qquad ( 2 )$$

b(m) represents the m^{th} data unit (bit data symbol) of the to-be-sent bit data. A value of initialized differential data is x(−1)=e^{jπ/4} or x(−1)=e^{-jπ/4}.

For another example, when the modulation scheme is QPSK modulation, a relationship between the to-be-sent bit data and the modulated data is shown in formula (3) or (4), and a relationship between the modulated data and the differential data is shown in formula (1).

$$d ( m ) = {e}^{j π / 4} [ ( 1 - 2 b ( 2 m ) ) + j ( 1 - 2 b ( 2 m + 1 ) ) ] \qquad ( 3 )$$

$$d ( m ) = {e}^{- j π / 4} [ ( 1 - 2 b ( 2 m ) ) + j ( 1 - 2 b ( 2 m + 1 ) ) ] \qquad ( 4 )$$

j represents an imaginary symbol. A value of initialized differential data is x(−1)=e^{jπ/4} or x(−1)=e^{-jπ/4}.

For another example, when the modulation scheme is Pi/2-BPSK modulation, a relationship between the to-be-sent bit data and the modulated data is shown in formula (2), and a relationship between the modulated data and the differential data is shown in formula (5).

$$x ( m ) = {e}^{j \frac{π ( m mod 2 )}{2}} x ( m - 1 ) d ( m ) \qquad ( 5 )$$

j represents an imaginary symbol. A value of initialized differential data is x(−1)=e^{jπ/4} or x(−1)=e^{-jπ/4}.

Alternatively, when the modulation scheme is Pi/2-BPSK modulation, a relationship between the to-be-sent bit data and the modulated data is shown in formula (6), and a relationship between the modulated data and the differential data is shown in formula (1).

$$d ( m ) = j [ 1 - 2 b ( m ) ] \qquad ( 6 )$$

A value of initialized differential data is x(−1)=e^{jπ/4} or x(−1)=e^{-jπ/4}.

It should be noted that the BPSK modulation scheme, the Pi/2-BPSK modulation scheme, and the QPSK modulation scheme described in this disclosure are obtained through improvement of a conventional BPSK modulation scheme, Pi/2-BPSK modulation scheme, and QPSK modulation scheme. Differential data generated through differential modulation performed by using the BPSK modulation scheme, the Pi/2-BPSK modulation scheme, and the QPSK modulation scheme in this disclosure is still BPSK modulated data, Pi/2-BPSK modulated data, and QPSK modulated data. In this way, a PAPR of data of an OFDM/SC-FDMA symbol generated based on the first data remains unchanged, and the data still features a low PAPR. This helps demodulate the data.

The following describes in detail the data processing method provided in this disclosure.

FIG. 3 is a schematic flowchart of a data processing method according to this disclosure. The data processing method is applied to the communication system shown in FIG. 1. For example, the data processing method may be implemented through interaction between a first communication device and a second communication device, and includes the following steps.

301. The first communication device obtains first data, where the first data includes at least two differential data symbols or at least two differential spreading data symbols.

In a possible implementation, when the first communication device performs differential modulation on modulated data to obtain the first data, the first data is differential data. For example, a relationship between the modulated data and the differential data satisfies formula (1). In this case, the first data includes the at least two differential data symbols. For example, x(m) represents the m^{th} differential data symbol of the differential data. m satisfies 0≤m≤M−1, where M represents a length of the differential data, and M is an integer greater than 1. The at least two differential data symbols are sent on at least two time domain symbols. For example, the first data is sent on/time domain symbols, where/is an integer greater than 1. It may be understood that, when the first data is sent on the at least two time domain symbols, in comparison with that the first data is sent on only one time domain symbol, the first communication device may more flexibly adapt to, based on a scenario of a time offset or a frequency offset, a mapping relationship between the first data and a time-frequency resource.

In another possible implementation, when the first communication device performs differential modulation on modulated data to obtain differential data, and performs spreading processing on the differential data, the first data is differential spreading data. For example, the first communication device determines a spreading sequence c_{SF}, and performs spreading on differential data X based on the spreading sequence c_{SF}, to obtain differential spreading data x_{S}. Different sending devices may perform spreading by using different spreading sequences. The different spreading sequences may be orthogonal, or may be non-orthogonal or quasi-orthogonal. It may be understood that when spreading sequences used by a plurality of terminal devices are non-orthogonal, a transmission process in which a plurality of first communication devices send data to the second communication device is a non-orthogonal multiple access transmission process.

Specifically, it is assumed that a length of the spreading sequence is K_{SF}, in other words, the spreading sequence includes K_{SF} elements, where K_{SF} is an integer greater than 1. K_{SF} may be referred to as a spreading factor. Values of the spreading factor and the spreading sequence may be predefined, or may be determined by the first communication device, or may be communicated by the second communication device to the first communication device by using signaling. A specific implementation is not limited in this disclosure. A length of the differential spreading data x_{S} is M_{S}, where M_{S} satisfies M_{S}=K_{SF}M. It may be understood that when the value of the spreading factor K_{SF} is 1, a spreading operation may be skipped. In other words, the differential spreading data is the same as the differential data.

In a possible implementation, a relationship between the differential data x and the differential spreading data x_{S} satisfies:

$${x}_{S} ( m * {K}_{SF} + t ) = x ( m ) {c}_{SF} ( t ) \qquad ( 7 )$$

c_{SF}(t) represents the t^{th} data unit (namely, the t^{th} element) of the spreading sequence, x_{S} (m*K_{SF}+t) represents the (m*K_{SF}+t)^{th} data unit (differential spreading data symbol) of the differential spreading data, and/satisfies 0≤t≤K_{SF}−1.

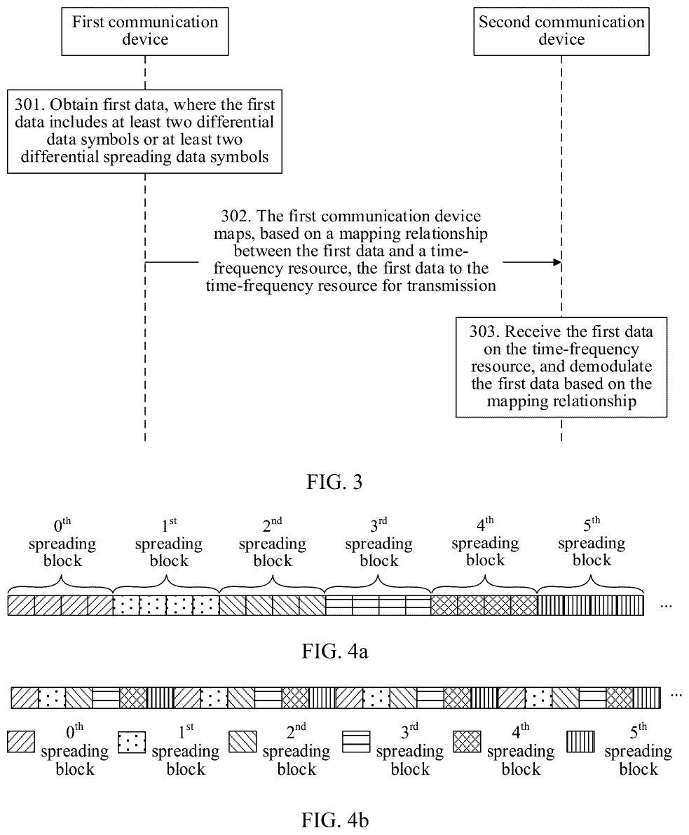

For ease of description, in this disclosure, K_{SF} output values obtained by multiplying the m^{th} differential data symbol x(m) of the differential data x by the spreading sequence c_{SF} are referred to as the m^{th} differential spreading data symbol block (also referred to as a spreading block). In this case, there are M differential spreading data symbol blocks (namely, M spreading blocks) in total. For example, FIG. 4a is a diagram of a type of differential spreading data according to this disclosure. One differential spreading data symbol block shown in FIG. 4a includes a plurality of differential spreading data symbols, and the differential spreading data symbol blocks are sequentially arranged. It is assumed that differential data includes six data units, such as, x=x(0), x(1), x(2), x(3), x(4), x(5), and a spreading sequence includes four data units, such as, c_{SF}=c_{SF}(0),c_{SF}(1),c_{SF}(2),c_{SF}(3). Therefore, the data units of the differential data x are multiplied by the spreading sequence, to obtain a plurality of differential spreading data symbols. For example, the 0^{th} to the 3^{rd} differential spreading data symbols (namely, the 0^{th} spreading block) may be represented as [x(0)c_{SF}(0),x(0)c_{SF}(1),x(0)c_{SF}(2),x(0)c_{SF}(3)]. The 4^{th} to the 7^{th} differential spreading data symbols (namely, the 1^{st} spreading block) may be represented as [x(1)C_{SF}(0),x(1)C_{SF}(1),x(1)c_{SF}(2),x(1)c_{SF}(3)]. The rest may be deduced by analogy. The differential spreading data shown in FIG. 4a includes 24 differential spreading data symbols.

In another possible implementation, a relationship between the differential data x and the differential spreading data x_{S} satisfies:

$${x}_{S} ( m + t * M ) = x ( m ) {c}_{SF} ( t ) \qquad ( 8 )$$

C_{SF}(t) represents the t^{th} data unit of the spreading sequence, x_{S}(m+t*M) represents the (m+1*M)^{th} data unit of the differential spreading data, and/satisfies 0≤t≤K_{SF}−1.

It may be understood that, in this implementation, the differential spreading data x_{S} is obtained by performing cross arrangement at a spacing of the length M of the differential data. For example, FIG. 4b is a diagram of another type of differential spreading data according to this disclosure. Differential data includes six data units, and a spreading sequence includes four data units. First, six values (namely, the 0^{th} differential spreading data symbols of six spreading blocks) are obtained by multiplying the differential data by the 0^{th} data unit of the spreading sequence, and the six values are sequentially arranged. Then, six values (namely, the 1^{st} differential spreading data symbols of the six spreading blocks) are obtained by multiplying the differential data by the 1^{st} data unit of the spreading sequence, and the six values are sequentially arranged. The rest may be deduced by analogy. The differential spreading data shown in FIG. 4b includes 24 differential spreading data symbols.

302. The first communication device maps, based on the mapping relationship between the first data and the time-frequency resource, the first data to the time-frequency resource for transmission.

The time-frequency resource is a time-frequency resource used by the first communication device to send the first data. The time-frequency resource may include but is not limited to a quantity of symbols for sending the data, a quantity of subcarriers included in a data bandwidth, a location of a symbol, a location of a subcarrier included in the data bandwidth (which may also be referred to as a location of the subcarrier for short), and the like. It should be noted that the time-frequency resource may be communicated by the second communication device to the first communication device, or may be determined by the first communication device. This is not limited in this disclosure. It should be further noted that the symbol for sending the data in the time-frequency resource may be an OFDM symbol or an SC-FDMA symbol. This is not limited in this disclosure.

Specifically, the quantity of symbols is represented as L The first data is sent on L symbols, where L is a positive integer greater than 1. In other words, the first data is sent on at least two symbols. The quantity of subcarriers included in the data bandwidth is represented as K. A data bandwidth corresponding to each symbol includes a same quantity of subcarriers. K data units of the first data may be sent on K subcarriers of each symbol. For example, the first communication device may send K differential data symbols. It may be understood that when the first data is the differential data, the L symbols have L×k=M subcarriers in total. In other words, the time-frequency resource includes the M subcarriers in total, on which M data units of the first data may be sent. An index of a symbol in the L symbols of the time-frequency resource is represented as l′, where l′ is an integer that satisfies 0≤l′≤L−1. An index of the K subcarriers of each symbol may be represented as k′, where k′ is an integer that satisfies 0≤k′≤K−1. Locations of the K subcarriers included in the data bandwidth are represented as Freq. For example, the locations of the K subcarriers may be locations of the K subcarriers in subcarriers included in a system bandwidth. It may be understood that I_{Freq} includes K elements. I_{Freq}(k′), k′=0,1, . . . , K−1 is a location of the k′^{th} subcarrier in the K subcarriers. Locations of K subcarriers in different symbols may be the same. Locations of the L symbols are represented as I_{Time}. For example, the locations of the L symbols for sending the data may be locations of the L symbols in all symbols for transmission. All the symbols for transmission may include the symbol for sending the data, or may include a symbol for sending a reference signal. I_{Time} includes L elements. I_{Time}(l′), l′=0,1, . . . . L−1 is a location of the l′^{th} symbol in the L symbols. It may be understood that the M subcarriers of the time-frequency resource correspond to the index l′ of the symbol and the index k′ of the subcarrier. The location l_{Time}(l′) of the l′^{th} symbol corresponds to the index (′ of the symbol. Therefore, a value of the index l′ of the symbol may also be referred to as the location of the l′^{th} symbol. The location I_{Freq}(k′) of the k′^{th} subcarrier corresponds to the index k′ of the subcarrier. Therefore, a value of the index k′ of the subcarrier may also be referred to as the location of the k′^{th} subcarrier. It may be understood that, when the first data is the differential spreading data, the L symbols have L×k=Mₛ subcarriers in total, and the M_{S} subcarriers of the time-frequency resource correspond to the index l′ of the symbol and the index k′ of the subcarrier.

When the first communication device generates the SC-FDMA symbol based on the first data, the time-frequency resource may further include but is not limited to the quantity of symbols for sending the data, a quantity of data units that can be sent on each symbol, the location of the symbol, a location of a data unit sent on each symbol, and the like. Specifically, the quantity of symbols is represented as L. The first data is sent on L symbols, where L is a positive integer greater than 1. In other words, the first data is sent on at least two symbols. The quantity of data units (for example, differential data symbols) that can be sent on each symbol is represented as K, and corresponds to K locations of data units sent on each symbol. The K locations of the data units sent on each symbol are represented as I_{Freq}, and locations of the L symbols are represented as I_{Time}. In this case, a location I_{Time}(l′) of the l′^{th} symbol corresponds to an index l′ of the symbol. The k′^{th} location I_{Freq}(k′) in the K locations of the data units sent on each symbol corresponds to the index k′.

The mapping relationship between the first data and the time-frequency resource may include the following several cases.

Case 1: The first data is the differential data, and the data unit is a differential data symbol. Alternatively, the first data is the differential spreading data, and the data unit is a differential spreading data symbol. The time-frequency resource includes L symbols and K subcarriers. The mapping relationship includes:

The first data is mapped along the L symbols in a first direction on the 2k^{th} subcarrier, and is mapped along the L symbols in a second direction on the (2p+1)^{th} subcarrier based on the data unit.

The first direction is opposite to the second direction. k is an integer that satisfies 0≤2k≤K−1, p is an integer that satisfies 0≤2p+1≤K−1, 1 is an integer that satisfies 0≤2l≤ L−1, and q is an integer that satisfies 0≤2q+1≤ L−1. L and K are integers greater than 1. It may be understood that the first direction may be a direction in which the symbol index increases, and the second direction is a direction in which the symbol index decreases. Alternatively, the first direction may be a direction in which the symbol index decreases, and the second direction is a direction in which the symbol index increases. This is not limited in this disclosure.

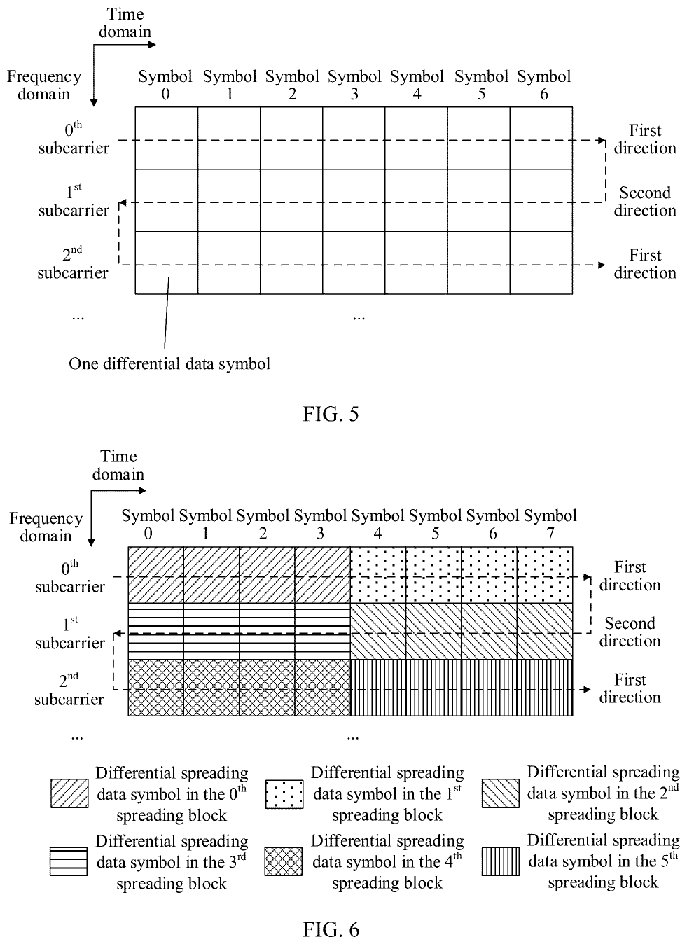

For example, FIG. 5 is a diagram of a first mapping relationship between differential data and a time-frequency resource according to this disclosure. A first communication device sends the differential data by using L=7 symbols in time domain. Specifically, the 0^{th} to the 6^{th} differential data symbols of the differential data are mapped along the seven symbols in a first direction (for example, the first direction in FIG. 5 is a direction in which a symbol index increases) on the 0^{th} subcarrier. Because a mapping direction of the differential data on the 1st subcarrier is opposite to the mapping direction of the differential data on the 0^{th} subcarrier, the 7^{th} to the 13^{th} differential data symbols of the differential data are mapped along the seven symbols in a second direction (a direction in which the symbol index decreases) on the 1st subcarrier. Because a mapping direction of the differential data on the 2^{nd} subcarrier is opposite to the mapping direction of the differential data on the 1^{st} subcarrier, the 14^{th} to the 20^{th} differential data symbols of the differential data are mapped along the seven symbols in the first direction on the 2^{nd} subcarrier. The rest may be deduced by analogy.

When the first communication device uses the mapping relationship shown in FIG. 5, the differential data is first mapped along different symbols in the first direction on the 2k^{th} subcarrier, and then mapped along the different symbols in the second direction on the (2p+1)^{th} subcarrier. The first direction is opposite to the second direction. In this way, frequency domain channels that two adjacent data units (namely, the m^{th} differential data symbol and the (m+1)^{th} differential data symbol of the differential data) in the differential data pass through can be the closest. For example, when channels with large frequency diversity are passed through, the frequency domain channels that the two adjacent data units in the differential data pass through are the closest. In addition, when a time offset causes a change in frequency domain channels of different subcarriers, the frequency domain channels that the two adjacent data units in the differential data pass through are still close. This helps improve demodulation performance.

It should be noted that in the mapping relationship shown in FIG. 5, data sent on the k′^{th} subcarrier in the l′^{th} symbol of the time-frequency resource is represented as x_{l′}^{MAP}(k). For example, the first direction is the direction in which the symbol index increases, and the second direction is the direction in which the symbol index decreases. In this case, a mapping relationship between the data x_{l′}^{MAP}(k′) sent on the k′^{th} subcarrier in the l′^{th} symbol and the differential data x satisfies:

$${x}_{{l}^{′}}^{MAP} ( {k}^{′} ) = \{ \begin{matrix}x ( {l}^{′} + {k}^{′} L ) , {k}^{′} = 2 k \\ x ( L - 1 - {l}^{′} + {k}^{′} L ) , {k}^{′} = 2 k + 1\end{matrix} \qquad ( 9 )$$

k′ is an integer that satisfies 0≤k′≤K−1, and l′ is an integer that satisfies 0≤l′≤L−1.

According to formula (9), the (l′+k′L)^{th} data unit of the differential data corresponds to the k′^{th} subcarrier in the l′^{th} symbol of the time-frequency resource. Similarly, data corresponding to the (l′+k′L)^{th} data unit of the differential data is consistent with data sent on the k′^{th} subcarrier in the l′^{th} symbol of the time-frequency resource. The mapping relationship between the differential data and the time-frequency resource is determined, in other words, a mapping relationship between the differential data and data sent on the time-frequency resource is determined.

For another example, FIG. 6 is a diagram of a first mapping relationship between differential spreading data and a time-frequency resource according to this disclosure. It is assumed that in the differential spreading data shown in FIG. 6, elements of all spreading blocks are sequentially arranged. A first communication device sends the differential spreading data by using L=8 symbols. Specifically, the 0^{th} to the 7^{th} differential spreading data symbols (namely, the 0^{th} spreading block and the 1^{st} spreading block) of the differential spreading data are mapped along the eight symbols in a first direction (for example, the first direction in FIG. 6 is a direction in which a symbol index increases) on the 0^{th} subcarrier. Because a mapping direction of the differential spreading data on the 1^{st} subcarrier is opposite to the mapping direction of the differential spreading data on the 0^{th} subcarrier, the 8^{th} to the 15^{th} differential spreading data symbols (namely, the 2^{nd} spreading block and the 3^{rd} spreading block) of the differential spreading data are mapped along the eight symbols in a second direction (a direction in which the symbol index decreases) on the 1^{st} subcarrier. Because a mapping direction of the differential spreading data on the 2^{nd} subcarrier is opposite to the mapping direction of the differential spreading data on the 1^{st} subcarrier, the 16^{th} to the 23^{rd} differential spreading data symbols (namely, the 4^{th} spreading block and the 5^{th} spreading block) of the differential spreading data are mapped along the eight symbols in the first direction on the 2nd subcarrier. The rest may be deduced by analogy

When the first communication device uses the mapping relationship shown in FIG. 6, the differential spreading data is first mapped along different symbols in the first direction on the 2k^{th} subcarrier, and then mapped along the different symbols in the second direction on the (2p+1)^{th} subcarrier. The first direction is opposite to the second direction. In this way, frequency domain channels that two adjacent differential spreading data symbols in the spreading blocks in the differential spreading data pass through can be the closest in a low-speed scenario. In addition, when a time offset causes a change in frequency domain channels of different subcarriers and a small frequency offset exists, the frequency domain channels that the two adjacent elements of the spreading blocks pass through are still the closest, and frequency domain channels that adjacent spreading blocks (namely, adjacent differential spreading data corresponding to the adjacent spreading blocks) pass through are close. This helps improve demodulation performance.

It should be noted that in the mapping relationship shown in FIG. 6, data sent on the k′^{th} subcarrier in the l′^{th} symbol of the time-frequency resource is represented as x_{l′}^{MAP}(k′). For example, the first direction is the direction in which the symbol index increases, and the second direction is the direction in which the symbol index decreases. In this case, a mapping relationship between the data x_{l′}^{MAP}(k′) sent on the k′^{th} subcarrier in the l′^{th} symbol and the differential data x_{S} satisfies:

$${x}_{{l}^{′}}^{MAP} ( {k}^{′} ) = \{ \begin{matrix}{x}_{S} ( {l}^{′} + {k}^{′} L ) , {k}^{′} = 2 k \\ {x}_{S} ( L - 1 - {l}^{′} + {k}^{′} L ) , {k}^{′} = 2 k + 1\end{matrix} \qquad ( 10 )$$

According to formula (10), the (l′+k′L)^{th} data unit of the differential spreading data corresponds to the k′^{th} subcarrier in the l′^{th} symbol of the time-frequency resource. Similarly, the (l′+k′L)^{th} data unit of the differential spreading data is consistent with data sent on the k′^{th} subcarrier in the l′^{th} symbol of the time-frequency resource. The mapping relationship between the differential spreading data and the time-frequency resource is determined, in other words, a mapping relationship between the differential spreading data and data sent on the time-frequency resource is determined.

Case 2: The first data is the differential spreading data, and the data unit is a differential spreading data symbol block. The differential spreading data symbol block includes l_{block}×k_{block} differential spreading data symbols. The time-frequency resource includes L symbols and K subcarriers. The mapping relationship includes:

The first data is mapped along the L symbols in a first direction between the 2k×k_{block}^{th} subcarrier and the ((2k+1)k_{block}−1)^{th} subcarrier, and is mapped along the L symbols in a second direction between the (2p+1)k_{block}^{th} subcarrier and the (2(p+1)k_{block}−1)^{th} subcarrier based on the data unit.

k is an integer that satisfies 0≤ (2k+1)k_{block}−K−1, p is an integer that satisfies 0≤2 (p+1)k_{block}−1≤K−1, l is an integer that satisfies 0≤(2l+1)l_{block}−1≤L−1, q is an integer that satisfies 0≤2 (q+1)l_{block}−1≤L−1, block is an integer that satisfies 1≤l_{block}≤L, and k_{block} is an integer that satisfies 1≤k_{block}≤ K.

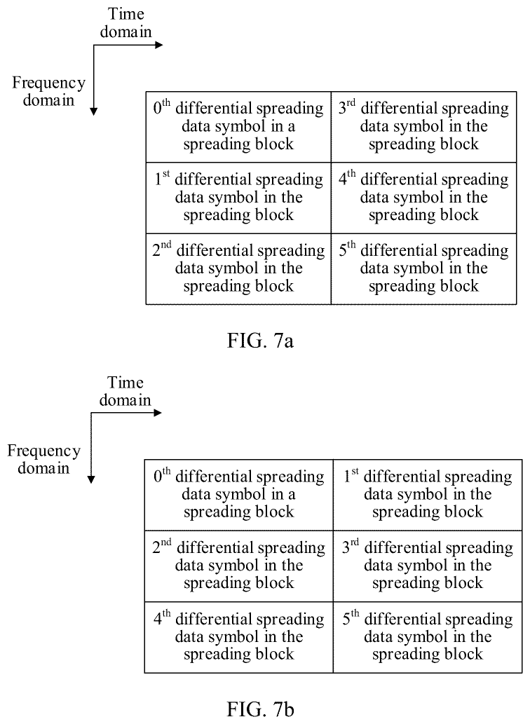

A spreading block in the differential spreading data may be mapped to a plurality of symbols and a plurality of subcarriers. Specifically, one spreading block includes K_{SF} differential spreading data symbols. One spreading block is mapped to l_{block} consecutive symbols. One spreading block is mapped to k_{block} consecutive subcarriers in each symbol. Values of block and k_{block} may be predefined, or may be communicated by the second communication device to the first communication device. This is not limited in this disclosure. For example, one spreading block includes K_{SF}=4 differential spreading data symbols, l_{block}=2, and k_{block}=2. For another example, one spreading block includes K_{SF}=6 differential spreading data symbols, l_{block}=2, and k_{block}=3, or l_{block}=3, and k_{block}=2. It may be understood that l_{block} and k_{block} may have a plurality of different values, to flexibly adapt to different scenarios, so that frequency domain channels that are passed through in the spreading block are closer. For example, for a low-speed scenario, a quantity block of symbols to which the spreading block is mapped may be greater than a quantity k_{block} of subcarriers; and for a high-speed scenario, a quantity block of symbols to which the spreading block is mapped may be less than a quantity k_{block} of subcarriers. A mapping manner of the differential spreading data symbols in the spreading block on the l_{block}×k_{block} subcarriers may be predefined, or may be communicated by the second communication device to the first communication device. For example, the mapping manner is predefined. The differential spreading data symbols in the spreading block may be first arranged along frequency domain, and then arranged along time domain; or may be first arranged along time domain, and then arranged along frequency domain. For example, FIG. 7a and FIG. 7b show mapping manners of six differential spreading data symbols in a spreading block on two consecutive symbols when l_{block}=2, and k_{block}=3, where each symbol has three subcarriers. FIG. 7a shows that the six differential spreading data symbols in the spreading block are first arranged along the three subcarriers in frequency domain, and then arranged along the two symbols in time domain. FIG. 7b shows that the six differential spreading data symbols in the spreading block are first arranged along the two symbols in time domain, and then arranged along the three subcarriers in frequency domain.

The mapping relationship between the differential spreading data and the time-frequency resource may be determined according to the mapping manner of the differential spreading data symbols in the spreading block and based on a mapping relationship between the spreading block and the time-frequency resource.

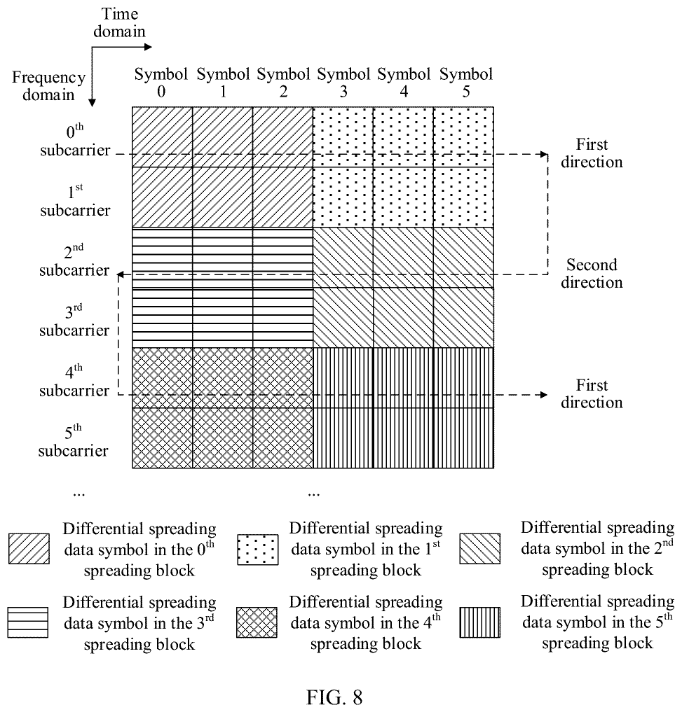

For example, FIG. 8 is a diagram of a second mapping relationship between differential spreading data and a time-frequency resource according to this disclosure. It is assumed that in the differential spreading data shown in FIG. 8, elements of all spreading blocks are sequentially arranged. A first communication device sends the differential spreading data by using L=6 symbols. One spreading block includes six differential spreading data symbols. It is assumed that the six differential spreading data symbols are mapped on three consecutive symbols, where each symbol has two consecutive subcarriers. The first communication device first maps the 0^{th} spreading block and the 1^{st} spreading block in a first direction (for example, the first direction in FIG. 8 is a direction in which a symbol index increases) on the 0^{th} subcarrier and the 1^{st} subcarrier. Then, the 2^{nd} spreading block and the 3^{rd} spreading block are mapped in a second direction (a direction in which the symbol index decreases) on the 2^{nd} subcarrier and the 3^{rd} subcarrier. Then, the 4^{th} spreading block and the 5^{th} spreading block are mapped in the first direction on the 4^{th} subcarrier and the 5^{th} subcarrier. The rest may be deduced by analogy.

When the first communication device uses the mapping relationship shown in FIG. 8, frequency domain channels that two adjacent differential spreading data symbols in the spreading block pass through are the closest in a low-speed scenario. In addition, when a change that is in frequency domain channels of different subcarriers and that is caused by a time offset is close to a change that is in frequency domain channels of different symbols and that is caused by a frequency offset, the frequency domain channels that the two adjacent differential spreading data symbols in the spreading block pass through are still the closest. In addition, frequency domain channels that adjacent spreading blocks (namely, adjacent differential spreading data corresponding to the adjacent spreading blocks) pass through can be close. This helps improve demodulation performance.

Case 3: The first data is the differential data, and the data unit is a differential data symbol. Alternatively, the first data is the differential spreading data, and the data unit is a differential spreading data symbol. The time-frequency resource includes L symbols and K subcarriers, and the mapping relationship includes:

The first data is mapped along the K subcarriers in a first direction on the 2l^{th} symbol, and is mapped along the K subcarriers in a second direction on the (2q+1)^{th} symbol based on the data unit.

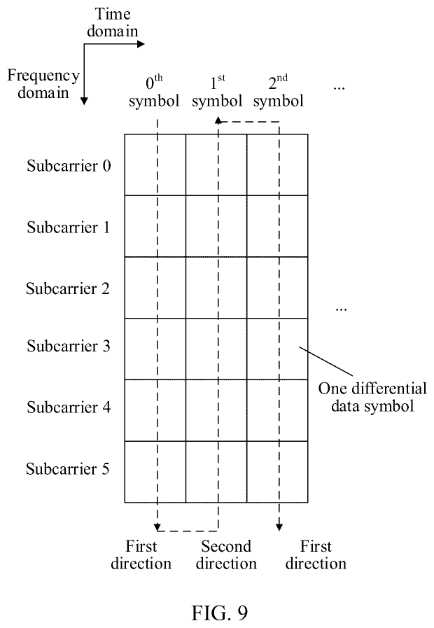

For example, FIG. 9 is a diagram of a second mapping relationship between differential data and a time-frequency resource according to this disclosure. A first communication device sends the differential data by using K=6 subcarriers in frequency domain. Specifically, the 0^{th} to the 5^{th} differential data symbols of the differential data are mapped along the six subcarriers in a first direction (for example, the first direction in FIG. 9 is a direction in which a subcarrier index increases) on the 0^{th} symbol. Because a mapping direction of the differential data on the 1^{st} symbol is opposite to the mapping direction of the differential data on the 0^{th} symbol, the 6^{th} to the 11^{th} differential data symbols of the differential data are mapped along the six subcarriers in a second direction (a direction in which the subcarrier index decreases) on the 1^{st} symbol. Because a mapping direction of the differential data on the 2^{nd} symbol is opposite to the mapping direction of the differential data on the 1^{st} symbol, the 12^{th} to the 17^{th} differential data symbols of the differential data are mapped along the six subcarriers in the first direction on the 2^{nd} symbol. The rest may be deduced by analogy.

When the first communication device uses the mapping relationship shown in FIG. 9, the differential data is first mapped along different subcarriers in the first direction on the 2l^{th} symbol, and then mapped along the different subcarriers in the second direction on the (2q+1)^{th} symbol. The first direction is opposite to the second direction. In this way, frequency domain channels that two adjacent data units in the differential data pass through can be the closest. For example, when the first communication device moves at a high speed, the frequency domain channels that the two adjacent data units in the differential data pass through can be the closest. In addition, when a frequency offset causes a change in frequency domain channels of different symbols, the frequency domain channels that the two adjacent data units in the differential data pass through are still close. This helps improve demodulation performance.

It should be noted that in the mapping relationship shown in FIG. 9, data sent on the k′^{th} subcarrier in the l′^{th} symbol of the time-frequency resource is represented as x_{l′}^{MAP}(k′). For example, the first direction is the direction in which the subcarrier index increases, and the second direction is the direction in which the subcarrier index decreases. In this case, a mapping relationship between the data x_{l′}^{MAP}(k′) sent on the k′^{th} subcarrier in the l′^{th} symbol and the differential data x satisfies:

$${x}_{{l}^{′}}^{MAP} ( {k}^{′} ) = \{ \begin{matrix}x ( {k}^{′} + {l}^{′} K ) , {l}^{′} = 2 l \\ x ( K - 1 - {k}^{′} + {l}^{′} K ) , {l}^{′} = 2 l + 1\end{matrix} \qquad ( 11 )$$

According to formula (11), the (k′+l′K)^{th} data unit of the differential data corresponds to the k′^{th} subcarrier in the l′^{th} symbol of the time-frequency resource. Similarly, the (k′+l′K)^{th} data unit of the differential data is consistent with data sent on the k′^{th} subcarrier in the l′^{th} symbol of the time-frequency resource. The mapping relationship between the differential data and the time-frequency resource is determined, in other words, a mapping relationship between the differential data and data sent on the time-frequency resource is determined.

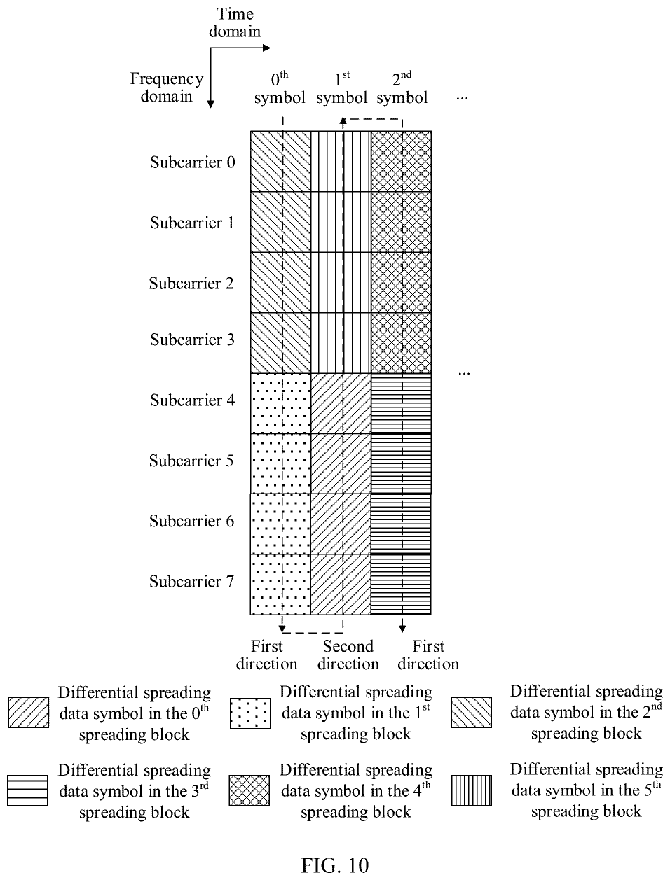

For another example, FIG. 10 is a diagram of a third mapping relationship between differential spreading data and a time-frequency resource according to this disclosure. It is assumed that in the differential spreading data shown in FIG. 10, elements of all spreading blocks are sequentially arranged. A first communication device sends the differential spreading data by using K=8 subcarriers. Specifically, the 0^{th} to the 7^{th} differential data symbols (namely, the 0^{th} spreading block and the 1^{st} spreading block) of the differential spreading data are mapped along the eight subcarriers in a first direction (for example, the first direction in FIG. 10 is a direction in which a subcarrier index increases) on the 0^{th} symbol. Because a mapping direction of the differential spreading data on the 1^{st} symbol is opposite to the mapping direction of the differential spreading data on the 0^{th} symbol, the 8^{th} to the 15^{th} elements (namely, the 2^{nd} spreading block and the 3^{rd} spreading block) of the differential spreading data are mapped along the eight subcarriers in a second direction (a direction in which the subcarrier index decreases) on the 1^{st} symbol. Because a mapping direction of the differential spreading data on the 2^{nd} symbol is opposite to the mapping direction of the differential spreading data on the 1^{st} symbol, the 16^{th} to the 23^{rd} elements (namely, the 4^{th} spreading block and the 5^{th} spreading block) of the differential spreading data are mapped along the eight subcarriers in the first direction on the 2^{nd} symbol. The rest may be deduced by analogy.

When the first communication device uses the mapping relationship shown in FIG. 10, the differential spreading data is first mapped along different subcarriers in the first direction on the 2l^{th} symbol, and then mapped along the different subcarriers in the second direction on the (2q+1)^{th} symbol. The first direction is opposite to the second direction. In this way, frequency domain channels that two adjacent data units in the spreading block pass through can be the closest in a high-speed scenario. In addition, when a frequency offset causes a change in frequency domain channels of different symbols and/or a small time offset exists, the frequency domain channels that the two adjacent data units in the spreading block pass through are still the closest. In addition, frequency domain channels that adjacent spreading blocks (namely, adjacent differential spreading data corresponding to the adjacent spreading blocks) pass through can be close. This helps improve demodulation performance.

It should be noted that in the mapping relationship shown in FIG. 10, data sent on the k′^{th} subcarrier in the l′^{th} symbol of the time-frequency resource is represented as x_{l′}^{MAP}(k′). For example, the first direction is the direction in which the subcarrier index increases, and the second direction is the direction in which the subcarrier index decreases. In. this case, a mapping relationship between the data x_{l′}^{MAP}(k′) sent on the k′^{th} subcarrier in the l′^{th} symbol and the differential spreading data x_{S} satisfies:

$${x}_{{l}^{′}}^{MAP} ( {k}^{′} ) = \{ \begin{matrix}{x}_{S} ( {k}^{′} + {l}^{′} K ) , {l}^{′} = 2 l \\ {x}_{S} ( K - 1 - {k}^{′} + {l}^{′} K ) , {l}^{′} = 2 l + 1\end{matrix} \qquad ( 12 )$$

According to formula (12), the (k′+′K)^{th} data unit of the differential spreading data corresponds to the k′^{th} subcarrier in the l′^{th} symbol of the time-frequency resource. Similarly, the (k′+l′K)^{th} data unit of the differential spreading data is consistent with data sent on the k′^{th} subcarrier in the l′^{th} symbol of the time-frequency resource. The mapping relationship between the differential spreading data and the time-frequency resource is determined, in other words, a mapping relationship between the differential spreading data and data sent on the time-frequency resource is determined.

Case 4: The first data is the differential spreading data, and the data unit is a differential spreading data symbol block. The differential spreading data symbol block includes l_{block}×k_{block} differential spreading data symbols. The time-frequency resource includes L symbols and K subcarriers. The mapping relationship includes:

The first data is mapped along the K subcarriers in a first direction between the 2l×l_{block}^{th} symbol and the ((2l+1)l_{block}*−1)^{th} symbol, and is mapped along the K subcarriers in a second direction between the (2q+1)l_{block}^{th} symbol and the (2(q+1)l_{block}−1)^{th} symbol based on the data unit.

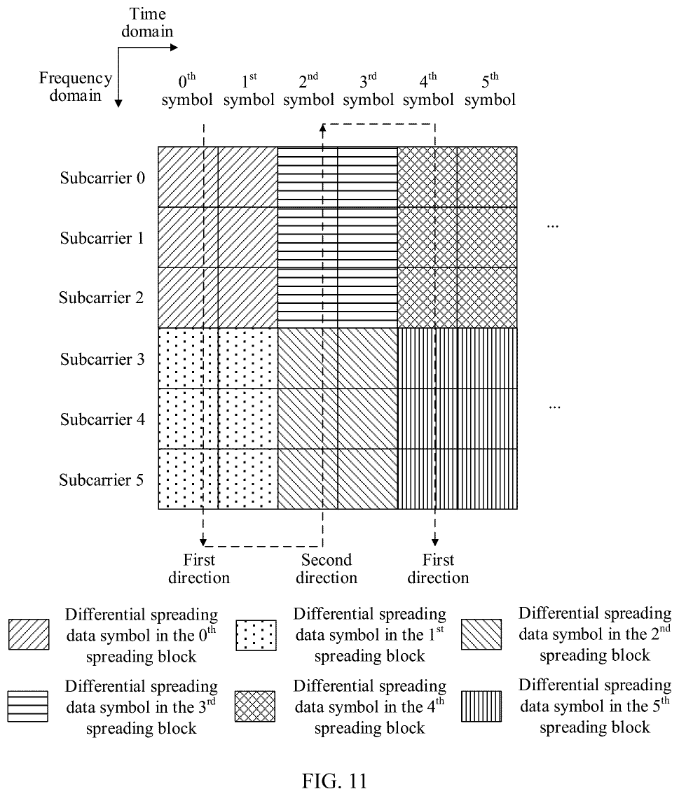

For example, FIG. 11 is a diagram of a fourth mapping relationship between differential spreading data and a time-frequency resource according to this disclosure. It is assumed that in the differential spreading data shown in FIG. 11, elements of all spreading blocks are sequentially arranged. A first communication device sends the differential spreading data by using K=6 subcarriers. One spreading block includes six differential spreading data symbols. It is assumed that the six differential spreading data symbols are mapped on two consecutive symbols, where each symbol has three consecutive subcarriers. The first communication device first maps the 0^{th} spreading block and the 1^{st} spreading block in a first direction (for example, the first direction in FIG. 11 is a direction in which a subcarrier index increases) on the 0^{th} symbol and the 1^{st} symbol. Then, the 2^{nd} spreading block and the 3^{rd} spreading block are mapped in a second direction (a direction in which the symbol index decreases) on the 2^{nd} symbol and the 3^{rd} symbol. Then, the 4^{th} spreading block and the 5^{th} spreading block are mapped in the first direction on the 4^{th} symbol and the 5^{th} symbol. The rest may be deduced by analogy.

When the first communication device uses the mapping relationship shown in FIG. 11, frequency domain channels that two adjacent differential spreading data symbols in the spreading block pass through are the closest in a high-speed scenario. In addition, when a change that is in frequency domain channels of different subcarriers and that is caused by a time offset is close to a change that is in frequency domain channels of different symbols and that is caused by a frequency offset, the frequency domain channels that the two adjacent differential spreading data symbols in the spreading block pass through are still the closest. In addition, frequency domain channels that adjacent spreading blocks (namely, adjacent differential spreading data corresponding to the adjacent spreading blocks) pass through can be close. This helps improve demodulation performance.

In a possible implementation, the mapping relationship described in Case 1 to Case 4 may be predefined. For example, the first communication device may predefine one of the mapping relationships shown in FIG. 5 to FIG. 11. There may also be N_{MAP} different mapping relationships between the differential data/differential spreading data and the time-frequency resource, where N_{MAP} is an integer greater than 1. The N_{MAP} different mapping relationships may be predefined, or may be indicated by higher layer signaling. The first communication device may select one mapping relationship from the N_{MAP} different mapping relationships as the mapping relationship between the differential data/differential spreading data and the time-frequency resource, and then may notify the second communication device of the selected mapping relationship through signaling.

In another possible implementation, the mapping relationship described in Case 1 to Case 4 may be communicated by the second communication device to the first communication device through a signaling indication. For example, signaling with log 2 ┌N_{MAP} ┐ bits may be used. Values of 0 to N_{MAP}−1 that are indicated by the signaling are in one-to-one correspondence with N_{MAP} different mapping relationships. The second communication device may send the value indicated by the signaling to the first communication device. The first communication device determines the mapping relationship between the differential data/differential spreading data and the time-frequency resource based on the value indicated by the obtained signaling.

The first communication device may map the differential data/differential spreading data based on the mapping relationship described in Case 1 to Case 4, to obtain data (namely, x_{l′}^{MAP}) sent on the l′^{th} symbol of the time-frequency resource. For the symbol l′, data of an OFDM symbol or data of an SC-FDMA symbol may be generated based on the data x_{l′}^{MAP} sent on the l′^{th} symbol of the time-frequency resource. In this way, the first communication device sends, on the time-frequency resource, the data of the OFDM symbol of the l′^{th} symbol or the data of the SC-FDMA symbol of the l′^{th} symbol.

In a possible implementation, that the first communication device maps the first data to the time-frequency resource for transmission may include the following steps:

s11. Map the first data to the time-frequency resource, and generate data of an orthogonal frequency division multiplexing symbol based on data on the time-frequency resource.

s12. Send the data of the orthogonal frequency division multiplexing symbol to the second communication device.

For example, data of an OFDM symbol is generated. Inverse Fourier transform may MAP be performed on data x_{l′}^{MAP} sent on the l′^{th} symbol of the time-frequency resource to obtain the data of the OFDM symbol. The inverse Fourier transform may be inverse discrete Fourier transform (IDFT), or inverse fast Fourier transform (IFFT), or may be inverse Fourier transform in another form. For a process of the inverse Fourier transform, refer to corresponding descriptions in a protocol standard. This is not limited in this disclosure.

In another possible implementation, that the first communication device maps the first data to the time-frequency resource for transmission may include the following steps:

s21. Map the first data to the time-frequency resource, and perform Fourier transform to obtain corresponding Fourier transform output data.

s22. Generate data of a single carrier frequency division multiple access symbol based on the Fourier transform output data.

s23. Send the data of the single carrier frequency division multiple access symbol to the second communication device.

In this case, the time-frequency resource may include but is not limited to a quantity of symbols for sending the data, a quantity of data units that can be sent on each symbol, a location of the symbol, a location of a data unit sent on each symbol, and the like.

For example, data of an SC-FDMA symbol is generated. Fourier transform may be performed on data x, sent on the l′^{th} symbol of the time-frequency resource to obtain Fourier transform output data (for example, represented as y_{l′}). Then, inverse Fourier transform is performed on the Fourier transform output data y_{l′} to obtain the data of the SC-FDMA symbol. Specifically, a relationship between the Fourier transform output data y_{l′} and the data x_{l′}^{MAP} sent on the l′^{th} symbol satisfies:

$${y}_{{l}^{′}} ( r ) = \frac{1}{\sqrt{K}} {\sum }_{{k}^{′} = 0}^{K - 1} {x}_{{l}^{′}}^{MAP} ( {k}^{′} ) \times {e}^{- j \frac{2 π {k}^{′} r}{K}} \qquad ( 13 )$$

y_{l′}(r) represents the r^{th} data unit (namely, the r^{th} value) of the output data y_{l′}, x_{l′}^{MAP}(k′) represents data sent at the k′^{th} location of the l′^{th} symbol, and r is an integer that satisfies 0≤r≤K−1. In this case, the r^{th} element of the Fourier transform output data y_{l′} corresponding to the l′^{th} symbol may be mapped to the r^{th} subcarrier in the time-frequency resource. In other words, the r^{th} element of y_{l′} is sent on the r^{th} subcarrier in the l′^{th} symbol of the time-frequency resource. The Fourier transform may be discrete Fourier transform (DFT) or fast Fourier transform (FFT), or may be Fourier transform in another form. For example, for a process of the Fourier transform, refer to corresponding descriptions in a protocol standard. This is not limited in this disclosure.

Optionally, the first communication device may output initialized differential data, or may not output the initialized differential data. It may be understood that the initialized differential data is an initial value of the first data.

In a possible implementation, the first communication device may not send the initialized differential data. In this case, the initialized differential data is known to both the first communication device and the second communication device. For example, the initialized differential data is a predefined value.

In another possible implementation, the second communication device may send the initialized differential data to the first communication device. The first communication device receives the initialized differential data, and generates the first data based on the initialized differential data. For example, the first communication device is a terminal device, and the second communication device is a base station device. The second communication device sends downlink control information (DCI) to the first communication device, where the DCI carries the initialized differential data. Alternatively, the second communication device sends higher layer signaling to the first communication device, where the higher layer signaling indicates a value of the initialized differential data.

In still another possible implementation, the first communication device may send the initialized differential data to the second communication device. For example, the first communication device is a terminal device, and the second communication device is a base station device. The first communication device sends an uplink control information (UCI) to the second communication device, where the message carries the initialized differential data. Alternatively, the first communication device sends higher layer signaling to the second communication device, where the higher layer signaling indicates a value of the initialized differential data. Alternatively, when the first communication device maps the first data to the time-frequency resource for transmission, the first communication device also transmits the initialized differential data.

Specifically, when the first communication device performs transmission once, the first communication device may send initialized differential data used for the transmission. For example, the first communication device may combine the initialized differential data and the differential data to obtain combined differential data. A relationship between the combined differential data, the initialized differential data, and the differential data satisfies:

$${x}_{1} ( {m}^{′} ) = \{ \begin{matrix}x ( - 1 ) , {m}^{′} = 0 \\ x ( {m}^{′} - 1 ) , {m}^{′} = 1 , 2 , … , M\end{matrix} \qquad ( 14 )$$

x(m′) represents the m′^{th} differential data symbol in at least two differential data symbols, x(−1) represents the initialized differential data, and x(m′) represents the m′^{th} element of the combined differential data. It may be understood that the combined differential data includes M+1 values. In this case, the first data may be the combined differential data, or the first data may be output data obtained by performing spreading processing on the combined differential data.

When the first communication device performs transmission more than once, the first communication device may send different transport blocks (TBs) in different transmission processes. Alternatively, the first communication device may divide one transport block into a plurality of subblocks and sequentially send the plurality of subblocks in different transmission processes. This is not limited in this disclosure. In this case, the first communication device may send the initialized differential data in the 1^{st} transmission process, and does not send the initialized differential data in a remaining transmission process. In the remaining transmission process, the initialized differential data is the initialized differential data used in the first transmission process.

The first communication device outputs the initialized differential data, so that phase ambiguity of the 0^{th} element of modulated data obtained by the second communication device through dedifferentiation can be avoided, thereby affecting demodulation performance.

303. The second communication device receives the first data on the time-frequency resource, and demodulates the first data based on the mapping relationship.

It may be understood that, in this disclosure, when the first data is data of different types, there are corresponding different demodulation schemes. For example, when the first data is the differential data, demodulating the first data represents dedifferentiation. When the first data is the differential spreading data, demodulating the first data represents dedifferentiation and despreading.

For example, the first communication device sends data of an OFDM symbol. The second communication device receives the data of the OFDM symbol sent by the first communication device, and then performs Fourier transform on the data of the OFDM symbol to obtain received frequency domain data. The second communication device obtains, from the received frequency domain data, data \tilde{x}_{l′}^{MAP} that is received on the l′^{th} symbol and that passes through a multipath channel. Differential data \tilde{x} that passes through the multipath channel may be obtained based on the mapping relationship between the differential data and the time-frequency resource and the data \tilde{x}_{l′}^{MAP} received on the l′^{th} symbol. Restored modulated data \tilde{d} is obtained by dedifferentiating the differential data \tilde{x} that passes through the multipath channel. BPSK modulation or QPSK modulation is used as an example. A relationship between the restored modulated data \tilde{d} and the differential data \tilde{x} that passes through the multipath channel satisfies:

$$\tilde{d} ( m ) = {[ \tilde{x} ( m - 1 ) ]}^{*} \times \tilde{x} ( m ) \qquad ( 15 )$$

[\tilde{x}(m−1)]^{⋅} represents a conjugate value of \tilde{x}(m−1).

For example, the terminal device sends data by using one antenna, and the base station device receives the data by using one antenna. A frequency domain channel that the differential data \tilde{x}(m) passes through may be represented as H(m). If impact of Gaussian noise is ignored, a relationship between the differential data \tilde{x} that passes through the multipath channel and the sent differential data x approximately satisfies:

$$\tilde{x} ( m ) = H ( m ) \times x ( m ) \qquad ( 16 )$$

Therefore, with reference to formula (15), formula (16), and the relationship between the differential data and the modulated data, the relationship between the restored modulated data \tilde{d} and the differential data \tilde{x} that passes through the multipath channel satisfies:

$$\begin{matrix}\tilde{d} ( m ) = {[ H ( m - 1 ) x ( m - 1 ) ]}^{*} \times [ H ( m ) x ( m ) ] \\ = {[ H ( m - 1 ) ]}^{*} H ( m ) \times {[ x ( m - 1 ) ]}^{*} x ( m ) \\ = {[ H ( m - 1 ) ]}^{*} H ( m ) \times d ( m )\end{matrix} \qquad ( 17 )$$

It may be understood that, when H(m−1)=H(m), [H(m−1)]^{⋅}H(m)=|H(m)|², where |H(m)| represents that a modulo operation is performed on H(m). In other words, when two adjacent elements of the differential data pass through a same frequency domain channel, the modulated data \tilde{d} restored by the second communication device and the modulated data d sent by the terminal device may have different amplitudes but a same phase. Based on low-order modulation such as the BPSK modulation and the QPSK modulation, good demodulation performance may be obtained.

Optionally, when the first communication device does not send the initialized differential data, and the initialized differential data known by the second communication device does not pass through a frequency domain channel, the 0^{th} element of the restored modulated data \tilde{d} satisfies:

$$\tilde{d} ( 0 ) = {[ x ( - 1 ) ]}^{*} \times [ H ( 0 ) x ( 0 ) ] = H ( 0 ) d ( 0 ) \qquad ( 18 )$$

In this case, a phase of the 0^{th} element \tilde{d}(0) of the restored modulated data d may be different from a phase of the 0^{th} element of the modulated data sent by the first communication device. A phase difference between the two phases is related to a frequency-domain channel H(0), and H(0) is unknown. In other words, the 0^{th} element \tilde{d}(0) of the restored modulated data \tilde{d} has phase ambiguity. When a length of the sent modulated data is short, the demodulation performance may be affected. Therefore, when the first communication device sends the data on each symbol by using K subcarriers, a quantity of symbols for sending the differential data may be increased. In other words, the differential data is sent on L>1 symbols, to increase a data length of the differential data (the modulated data), so as to reduce impact of the 0^{th} element of the modulated data restored by the second communication device on the demodulation performance due to the phase ambiguity.

In a possible implementation, when a time offset exists, it may be considered that frequency domain channels of different subcarriers of each symbol are multiplied by a phase, and a value of the phase is related to a value of the time offset and an index of the subcarrier. For example, the first communication device uses one antenna to send data, and the second communication device uses one antenna to receive the data. A frequency domain channel that the differential data \tilde{x}(m) (namely, the m^{th} differential data symbol of the differential data) passes through may be represented as H(m). If impact of Gaussian noise is ignored, a relationship between the differential data \tilde{x} that passes through the multipath channel and the sent differential data x approximately satisfies:

$$\tilde{x} ( m ) = H ( m ) \times x ( m ) {e}^{f 2 {πα}^{*} {k}^{′}} \qquad ( 19 )$$

A parameter α in the phase e^{j2πα*k′} is determined based on the value of the time offset. An index k′ represents an index of a subcarrier to which the differential data x(m) is mapped. It may be understood that an equivalent frequency domain channel that frequency domain data passes through is represented as H(m) multiplying by the phase e^{j2πα*k′}.

For example, in the mapping relationship shown in FIG. 5, indexes of subcarriers of most two adjacent differential data symbols are the same, and indexes of the symbols are different. In other words, for most values of m, subcarrier indexes of x(m) and x(m−1) are the same. In this case, the relationship between the restored modulated data d and the differential data x that passes through the multipath channel satisfies:

$$\begin{matrix}\tilde{d} ( m ) = {[ H ( m - 1 ) x ( m - 1 ) {e}^{j 2 π {α}^{*} {k}^{′}} ]}^{*} \times [ H ( m ) x ( m ) {e}^{j 2 π {α}^{*} {k}^{′}} ] \\ = {[ H ( m - 1 ) ]}^{*} H ( m ) \times {[ x ( m - 1 ) ]}^{*} x ( m ) \\ = {[ H ( m - 1 ) ]}^{*} H ( m ) \times d ( m )\end{matrix} \qquad ( 20 )$$

It can be learned from formula (20) that the restored modulated data \tilde{d} is irrelevant to the phase factor e^{j2πα*k′}. In other words, interference caused by the phase e^{j2πα*k′} introduced by the time offset is eliminated. Therefore, the mapping relationship shown in FIG. may be used to resist the interference caused by the time offset.

It may be understood that a larger time offset indicates a faster change in the value of the phase corresponding to two adjacent subcarriers. In other words, a faster change in frequency domain channels of different subcarriers indicates a larger value (or amplitude) of the parameter α. In this case, the differential data is first mapped along different symbols in a first direction on the 2k^{th} subcarrier based on the mapping relationship shown in FIG. 5, and then mapped along the different symbols in a second direction on the (2p+1)^{th} subcarrier. In this way, locations of subcarriers of most two adjacent data units in the differential data may be the same, and a symbol location difference is 1. In this way, when the second communication device performs dedifferention, frequency domain channels that two adjacent data units in the differential data pass through is slightly affected by the time offset, thereby improving demodulation performance of the receiver when the time offset exists.

In another possible implementation, when a frequency offset exists, frequency domain channels of different symbols of each subcarrier are also multiplied by one phase, and a value of the phase is related to a value of the frequency offset and an index of the symbol. It may be understood that a larger frequency offset indicates a faster change in the value of the phase corresponding to two adjacent symbols, in other words, indicates a faster change in frequency domain channels of different symbols. In this case, the differential data is first mapped along different subcarriers in a first direction on the 2l^{th} symbol, and then mapped along the different subcarriers in a second direction on the (2q+1)^{th} symbol. In this mapping manner, locations of symbols of most two adjacent data units in the differential data may be the same, and a subcarrier location difference is 1. In this way, when the second communication device performs dedifferention, frequency domain channels that two adjacent data units in the differential data pass through is slightly affected by the frequency offset, thereby improving demodulation performance of the receiver when the frequency offset exists.

In conclusion, this disclosure provides a plurality of different mapping relationships between differential data/differential spreading data and a time-frequency resource, to adapt to requirements of different time offsets and/or frequency offsets. A transmitter may select an appropriate mapping relationship between the differential data/differential spreading data and the time-frequency resource based on a value of the time offset and/or the frequency offset, to reduce a channel change between two adjacent pieces of differential data during dedifferention by a receiver. This helps improve demodulation performance of the receiver.

In an example, the mapping relationship between the first data and the time-frequency resource in step 302 may further include the following several cases.

Case 5: The first data is the differential data, and the data unit is a differential data symbol. Alternatively, the first data is the differential spreading data, and the data unit is a differential spreading data symbol. The time-frequency resource includes L symbols and K subcarriers. The mapping relationship includes:

The first data is mapped along the L symbols in a first direction on the 2k^{th} subcarrier, and is mapped along the L symbols in the first direction on the (2p+1)^{th} subcarrier based on the data unit.

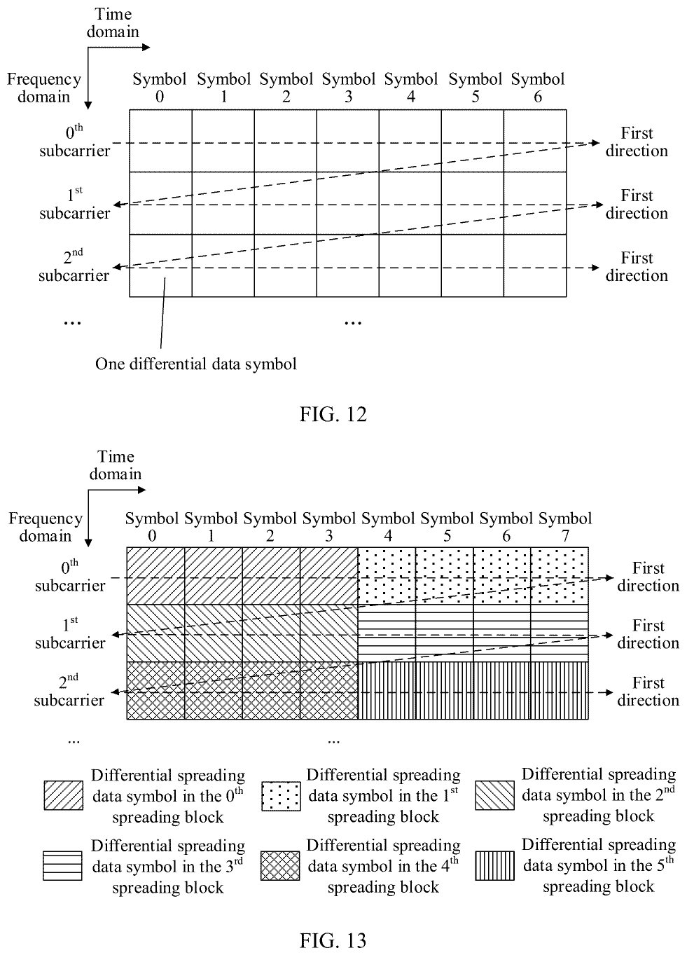

For example, FIG. 12 is a diagram of a third mapping relationship between differential data and a time-frequency resource according to this disclosure. A first communication device sends the differential data by using L=7 symbols in time domain. Specifically, the 0^{th} to the 6^{th} differential data symbols of the differential data are mapped along the seven symbols in a first direction (for example, the first direction in FIG. 12 is a direction in which a symbol index increases) on the 0^{th} subcarrier. The 7^{th} to the 13^{th} differential data symbols of the differential data continue to be mapped along the seven symbols in the first direction on the 1^{st} subcarrier. The 14^{th} to the 20^{th} differential data symbols of the differential data continue to be mapped along the seven symbols in the first direction on the 2^{nd} subcarrier. The rest may be deduced by analogy.

When the first communication device uses the mapping relationship shown in FIG. 12, the differential data is first mapped along different symbols in the first direction on the 2k^{th} subcarrier, and then continues to be mapped along the different symbols in the first direction on the (2p+1)^{th} subcarrier. When no time offset exists, implementation is easy to perform in this mapping manner. When a time offset causes a change in frequency domain channels of different subcarriers, frequency domain channels that two adjacent data units in the differential data pass through can be as close as possible. This helps improve demodulation performance.

It should be noted that in the mapping relationship shown in FIG. 12, data sent on the k′^{th} subcarrier in the l′^{th} symbol of the time-frequency resource is represented as x_{l′}^{MAP}(k′). For example, the first direction is the direction in which the symbol index increases, and a second direction is a direction in which the symbol index decreases. In this case, a mapping relationship between the data x_{l′}^{MAP}(k′) sent on the k′^{th} subcarrier in the l′^{th} symbol and the differential data x satisfies:

$${x}_{{l}^{′}}^{MAP} ( {k}^{′} ) = x ( {l}^{′} + {k}^{′} L ) \qquad ( 21 )$$

According to formula (21), the (l′+k′L)^{th} data unit of the differential data corresponds to the k′^{th} subcarrier in the l′^{th} symbol of the time-frequency resource. Similarly, the (l′+k′L)^{th} data unit of the differential data is consistent with data sent on the k′^{th} subcarrier in the l′^{th} symbol of the time-frequency resource. The mapping relationship between the differential data and the time-frequency resource is determined, in other words, a mapping relationship between the differential data and data sent on the time-frequency resource is determined.

For another example, FIG. 13 is a diagram of a fifth mapping relationship between differential spreading data and a time-frequency resource according to this disclosure. It is assumed that in the differential spreading data shown in FIG. 13, elements of all spreading blocks are sequentially arranged. A first communication device sends the differential spreading data by using L=8 symbols. Specifically, the 0^{th} to the 7^{th} differential spreading data symbols (namely, the 0^{th} spreading block and the 1^{st} spreading block) of the differential spreading data are mapped along the eight symbols in a first direction (for example, the first direction in FIG. 13 is a direction in which a symbol index increases) on the 0^{th} subcarrier. The 8^{th} to the 15^{th} differential spreading data symbols (namely, the 2^{nd} spreading block and the 3^{rd} spreading block) of the differential spreading data continue to be mapped along the eight symbols in the first direction on the 1^{st} subcarrier. The 16^{th} to the 23^{rd} differential spreading data symbols (namely, the 4^{th} spreading block and the 5^{th} spreading block) of the differential spreading data continue to be mapped along the eight symbols in the first direction on the 2^{nd} subcarrier. The rest may be deduced by analogy.

When the first communication device uses the mapping relationship shown in FIG. 13, the differential spreading data is first mapped along different symbols in the first direction on the 2k^{th} subcarrier, and then continues to be mapped along the different symbols in the first direction on the (2p+1)^{th} subcarrier. When no time offset exists, implementation is easy to perform in this mapping manner. When a time offset causes a change in frequency domain channels of different subcarriers, frequency domain channels that two adjacent data units in the spreading block pass through can be as close as possible, and frequency domain channels that adjacent spreading blocks (namely, adjacent differential data corresponding to the adjacent spreading blocks) pass through can be close as possible. This helps improve demodulation performance.

It should be noted that in the mapping relationship shown in FIG. 13, data sent on the k′^{th} subcarrier in the l′^{th} symbol of the time-frequency resource is represented as x_{l′}^{MAP}(k′). For example, the first direction is the direction in which the symbol index increases, and a second direction is a direction in which the symbol index decreases. In this case, a mapping relationship between the data x_{l′}^{MAP}(k′) sent on the k′^{th} subcarrier in the l′^{th} symbol and the differential data x_{S} satisfies:

$${x}_{{l}^{′}}^{MAP} ( {k}^{′} ) = {x}_{s} ( {l}^{′} + {k}^{′} L ) \qquad ( 22 )$$

According to formula (22), the (l′+k′L)^{th} element of the differential spreading data corresponds to the k′^{th} subcarrier in the l′^{th} symbol of the time-frequency resource. Similarly, the (l′+k′L)^{th} element of the differential spreading data is consistent with data sent on the k′^{th} subcarrier in the l′^{th} symbol of the time-frequency resource. The mapping relationship between the differential spreading data and the time-frequency resource is determined, in other words, a mapping relationship between the differential spreading data and data sent on the time-frequency resource is determined.

Case 6: The first data is the differential data, and the data unit is a differential data symbol. Alternatively, the first data is the differential spreading data, and the data unit is a differential spreading data symbol. The time-frequency resource includes L symbols and K subcarriers, and the mapping relationship includes:

The first data is mapped along the K subcarriers in a first direction on the 27^{th} symbol, and is mapped along the K subcarriers in the first direction on the (2q+1)^{th} symbol based on the data unit.

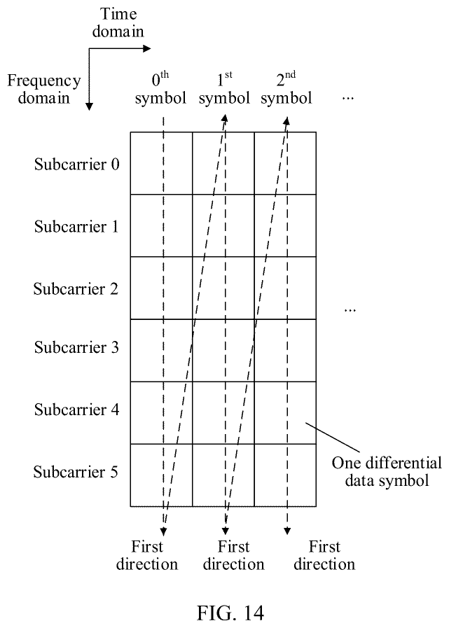

For example, FIG. 14 is a diagram of a fourth mapping relationship between differential data and a time-frequency resource according to this disclosure. A first communication device sends the differential data by using K=6 subcarriers in frequency domain. Specifically, the 0^{th} to the 5^{th} differential data symbols of the differential data are mapped along the six subcarriers in a first direction (for example, the first direction in FIG. 14 is a direction in which a subcarrier index increases) on the 0^{th} symbol. The 6^{th} to the 11^{th} differential data symbols of the differential data continue to be mapped along the six subcarriers in the first direction on the 1^{st} symbol. The 12^{th} to the 17^{th} differential data symbols of the differential data continue to be mapped along the six subcarriers in the first direction on the 2nd symbol. The rest may be deduced by analogy.

When the first communication device uses the mapping relationship shown in FIG. 14, the differentia data is first mapped along different subcarriers in the first direction on the 2l^{th} symbol, and then continues to be mapped along the different subcarriers in the first direction on the (2q+1)^{th} symbol. When no frequency offset exists, implementation is easy to perform in this mapping manner. When a frequency offset causes a change in frequency domain channels of different symbols, frequency domain channels that two adjacent data units in the differential data pass through can be as close as possible. This helps improve demodulation performance.

It should be noted that in the mapping relationship shown in FIG. 14, data sent on the k′^{th} subcarrier in the l′^{th} symbol of the time-frequency resource is represented as x_{l′}^{MAP}(k′). For example, the first direction is the direction in which the subcarrier index increases, and a second direction is a direction in which the subcarrier index decreases. In this case, a mapping relationship between the data x_{l′}^{MAP}(k′) sent on the k′^{th} subcarrier in the l′^{th} symbol and the differential data x satisfies:

$${x}_{{l}^{′}}^{MAP} ( {k}^{′} ) = x ( {k}^{′} + {l}^{′} K ) \qquad ( 23 )$$

According to formula (23), the (k′+l′K)^{th} data unit of the differential data corresponds to the k′^{th} subcarrier in the l′^{th} symbol of the time-frequency resource. Similarly, the (k′+l′K)^{th} data unit of the differential data is consistent with data sent on the k′^{th} subcarrier in the l′^{th} symbol of the time-frequency resource. The mapping relationship between the differential data and the time-frequency resource is determined, in other words, a mapping relationship between the differential data and data sent on the time-frequency resource is determined.

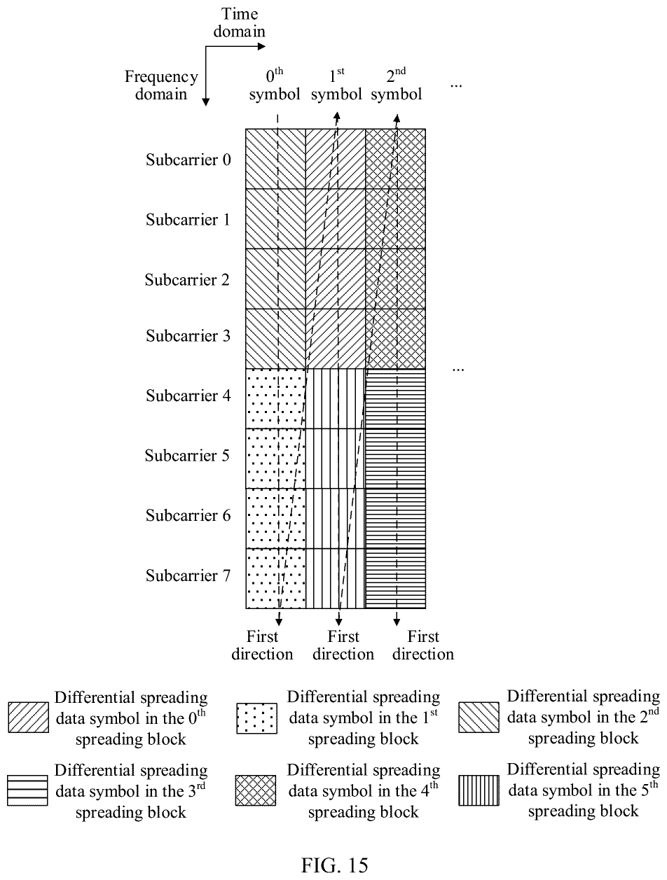

For another example, FIG. 15 is a diagram of a sixth mapping relationship between differential spreading data and a time-frequency resource according to this disclosure. It is assumed that in the differential spreading data shown in FIG. 15, elements of all spreading blocks are sequentially arranged. A first communication device sends the differential spreading data by using K=8 subcarriers. Specifically, the 0^{th} to the 7^{th} differential data symbols (namely, the 0^{th} spreading block and the 1^{st} spreading block) of the differential spreading data are mapped along the eight subcarriers in a first direction (for example, the first direction in FIG. 15 is a direction in which a subcarrier index increases) on the 0^{th} symbol. The 8^{th} to the 15^{th} elements (namely, the 2^{nd} spreading block and the 3^{rd} spreading block) of the differential spreading data continue to be mapped along the eight subcarriers in the first direction on the 1^{st} symbol. The 16^{th} to the 23^{rd} elements (namely, the 4^{th} spreading block and the 5^{th} spreading block) of the differential spreading data continue to be mapped along the eight subcarriers in the first direction on the 2^{nd} symbol. The rest may be deduced by analogy.

When the first communication device uses the mapping relationship shown in FIG. 15, the differential spreading data is first mapped along different subcarriers in the first direction on the 2l^{th} symbol, and then continues to be mapped along the different subcarriers in the first direction on the (2q+1)^{th} symbol. When no frequency offset exists, implementation is easy to perform in this mapping manner. When a frequency offset causes a change in frequency domain channels of different symbols, frequency domain channels that two adjacent data units in the spreading block pass through can be as close as possible. In addition, frequency domain channels that adjacent spreading blocks (namely, adjacent differential spreading data corresponding to the adjacent spreading blocks) pass through can be as close as possible. This helps improve demodulation performance.

It should be noted that in the mapping relationship shown in FIG. 15, data sent on the k′^{th} subcarrier in the l′^{th} symbol of the time-frequency resource is represented as x_{l′}^{MAP}(k′). For example, the first direction is the direction in which the subcarrier index increases, and a second direction is a direction in which the subcarrier index decreases. In this case, a mapping relationship between the data x_{l′}^{MAP}(k′) sent on the k′^{th} subcarrier in the l′^{th} symbol and the differential spreading data x_{S} satisfies:

$${x}_{{l}^{′}}^{MAP} ( {k}^{′} ) = {x}_{s} ( {k}^{′} + {l}^{′} K ) \qquad ( 24 )$$

According to formula (24), the (k′+l′K)^{th} data unit of the differential spreading data corresponds to the k′^{th} subcarrier in the l′^{th} symbol of the time-frequency resource. Similarly, the (k′+l′K)^{th} data unit of the differential spreading data is consistent with data sent on the k′^{th} subcarrier in the l′^{th} symbol of the time-frequency resource. The mapping relationship between the differential spreading data and the time-frequency resource is determined, in other words, a mapping relationship between the differential spreading data and data sent on the time-frequency resource is determined.

Case 7: The first data is the differential spreading data, and the data unit is a differential spreading data symbol block. The differential spreading data symbol block includes l_{block}×k_{block} differential spreading data symbols. The time-frequency resource includes L symbols and K subcarriers. The mapping relationship includes:

The first data is mapped along the L symbols in a first direction between the 2k×k_{block}^{th} subcarrier and the ((2k+1)k_{block}−1)^{th} subcarrier, and is mapped along the L symbols in the first direction between the (2p+1)k_{block}^{th} subcarrier and the (2(p+1)k_{block}−1)^{th} subcarrier based on a data unit.

A spreading block in the differential spreading data may be mapped to a plurality of symbols and a plurality of subcarriers. For some implementations, refer to corresponding descriptions in the embodiments in FIG. 7a and FIG. 7b. Details are not described herein again. The mapping relationship between the differential spreading data and the time-frequency resource may be determined according to a mapping manner of the differential spreading data symbols in the spreading block and based on a mapping relationship between the spreading block and the time-frequency resource.

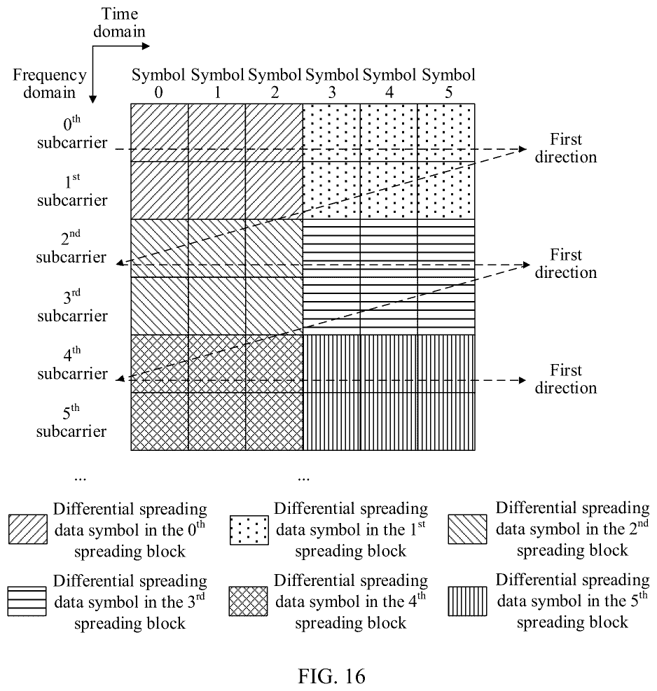

For example, FIG. 16 is a diagram of a seventh mapping relationship between differential spreading data and a time-frequency resource according to this disclosure. It is assumed that in the differential spreading data shown in FIG. 16, elements of all spreading blocks are sequentially arranged. A first communication device sends the differential spreading data by using L=6 symbols. One spreading block includes six differential spreading data symbols. It is assumed that the six differential spreading data symbols are mapped on three consecutive symbols, where each symbol has two consecutive subcarriers. The first communication device first maps the 0^{th} spreading block and the 1^{st} spreading block in a first direction (for example, the first direction in FIG. 16 is a direction in which a symbol index increases) on the 0^{th} subcarrier and the 1^{st} subcarrier. Then, the 2^{nd} spreading block and the 3^{rd} spreading block continue to be mapped in the first direction on the 2^{nd} subcarrier and the 3^{rd} subcarrier. Then, the 4^{th} spreading block and the 5^{th} spreading block continue to be mapped in the first direction on the 4^{th} subcarrier and the 5^{th} subcarrier. The rest may be deduced by analogy.

When the first communication device uses the mapping relationship shown in FIG. 16, frequency domain channels that two adjacent data units in the spreading block pass through can be as close as possible in a low-speed scenario. When a change that is in frequency domain channels of different subcarriers and that is caused by a time offset is close to a change that is in frequency domain channels of different symbols and that is caused by a frequency offset, the frequency domain channels that the two adjacent data units in the spreading block pass through are as close as possible. In addition, frequency domain channels that most adjacent spreading blocks (namely, adjacent differential spreading data corresponding to the most adjacent spreading blocks) pass through can be as close as possible. This helps improve demodulation performance.

Case 8: The first data is the differential spreading data, and the data unit is a differential spreading data symbol block. The differential spreading data symbol block includes l_{block}×k_{block} differential spreading data symbols. The time-frequency resource includes L symbols and K subcarriers. The mapping relationship includes:

The first data is mapped along the K subcarriers in a first direction between the 2l×l_{block}^{th} symbol and the ((2l+1)l_{block}−1)^{th} symbol, and is mapped along the K subcarriers in the first direction between the (2q+1)/l_{block}^{th} symbol and the (2(q+1)l_{block}−1)^{th} symbol based on the data unit.

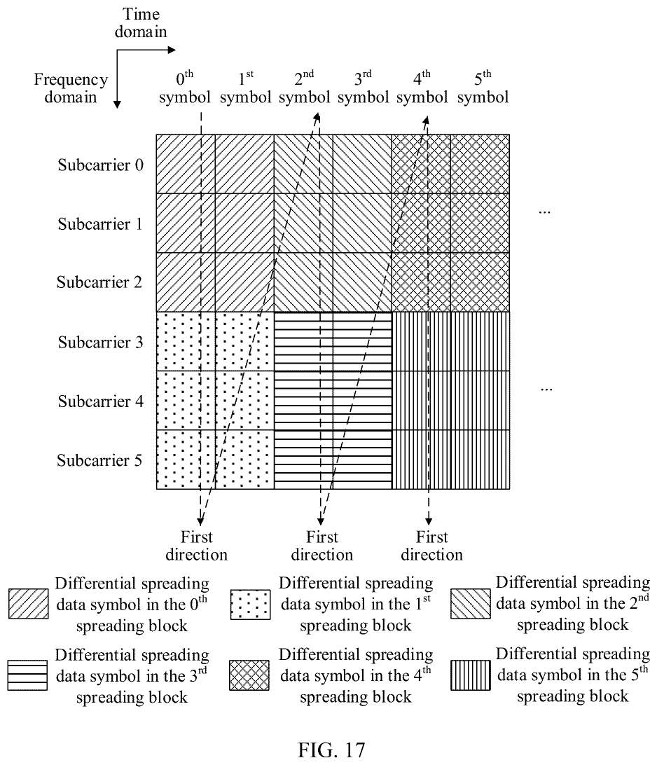

For example, FIG. 17 is a diagram of an eighth mapping relationship between differential spreading data and a time-frequency resource according to this disclosure. It is assumed that in the differential spreading data shown in FIG. 17, elements of all spreading blocks are sequentially arranged. A first communication device sends the differential spreading data by using K=6 subcarriers. One spreading block includes six differential spreading data symbols. It is assumed that the six differential spreading data symbols are mapped on two consecutive symbols, where each symbol has three consecutive subcarriers. The first communication device first maps the 0^{th} spreading block and the 1^{st} spreading block in a first direction (for example, the first direction in FIG. 17 is a direction in which a subcarrier index increases) on the 0^{th} symbol and the 1^{st} symbol. Then, the 2^{nd} spreading block and the 3rd spreading block continue to be mapped in the first direction on the 2^{nd} symbol and the 3rd symbol. Then, the 4^{th} spreading block and the 5^{th} spreading block continue to be mapped in the first direction on the 4^{th} symbol and the 5^{th} symbol. The rest may be deduced by analogy.

When the first communication device uses the mapping relationship shown in FIG. 17, frequency domain channels that two adjacent differential spreading data symbols in the spreading block pass through can be as close as possible in a high-speed scenario. When a change that is in frequency domain channels of different subcarriers and that is caused by a time offset is close to a change that is in frequency domain channels of different symbols and that is caused by a frequency offset, the frequency domain channels that the two adjacent differential spreading data symbols in the spreading block pass through are as close as possible. In addition, frequency domain channels that most adjacent spreading blocks (namely, adjacent differential spreading data corresponding to the most adjacent spreading blocks) pass through can be as close as possible. This helps improve demodulation performance.

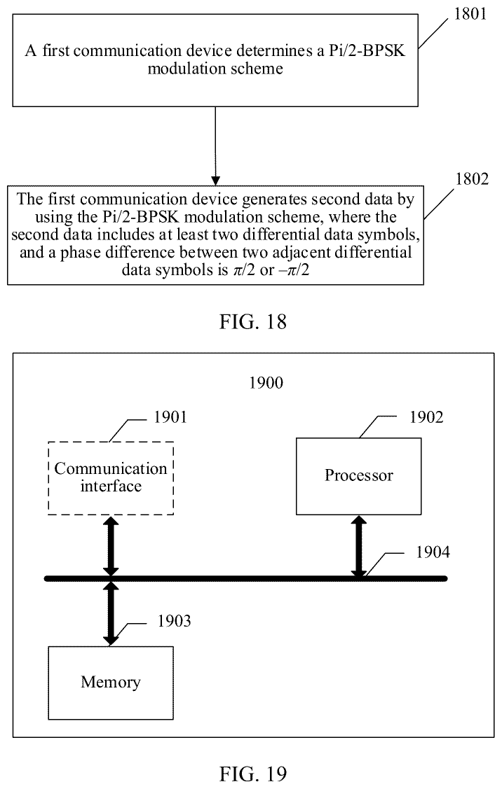

FIG. 18 is a schematic flowchart of another data processing method according to this disclosure. The data processing method is applied to the communication system shown in FIG. 1. For example, the data processing method may be performed by a first communication device, and includes the following steps:

1801. The first communication device determines a Pi/2-BPSK modulation scheme.

1802. The first communication device generates second data by using the Pi/2-BPSK modulation scheme, where the second data includes at least two differential data symbols, and a phase difference between two adjacent differential data symbols is π/2 or −π/2. That the first communication device generates the second data by using the Pi/2-BPSK modulation scheme may be: modulating to-be-sent bit data to obtain modulated data, and performing differential modulation on the modulated data to obtain the second data. The modulated data includes at least two data units (namely, at least two modulated data symbols), and the second data includes at least two data units (namely, the at least two differential data symbols).

The step 1801 and the step 1802 may be understood as steps of obtaining the second data by the first communication device. Specifically, the Pi/2-BPSK modulation scheme described in this disclosure is obtained through improvement of a conventional Pi/2-BPSK modulation scheme, so that the second data generated through differential modulation performed by using the Pi/2-BPSK modulation scheme in this disclosure is still Pi/2-BPSK modulated data, and still features a low PAPR. This helps demodulate the data.

In the conventional Pi/2-BPSK modulation scheme, modulated data is obtained by modulating to-be-sent bit data, and a phase difference between two adjacent modulated symbols of the modulated data is π/2 or −π/2. A PAPR of an SC-FDMA symbol generated based on the modulated data is low, and the symbol features a low PAPR. This helps increase transmit power of the generated SC-FDMA symbol and improve demodulation performance. It may be understood that the first communication device may generate, based on each modulated symbol of the modulated data, an SC-FDMA symbol of the modulated symbol, and then superimpose SC-FDMA symbols of all modulated symbols to obtain the SC-FDMA symbol generated based on the modulated data. Therefore, because the phase difference between the two adjacent modulated symbols of the modulated data is π/2 or −π/2, that SC-FDMA symbols of the two adjacent modulated symbols are superposed in a same direction is avoided, so that an amplitude of a maximum value of the SC-FDMA symbol obtained through superposition can be greatly reduced, and the symbol features a low PAPR.

However, if modulated symbols are generated according to the conventional Pi/2-BPSK modulation scheme a phase difference between two adjacent modulated symbols is π/2 or −π/2), and differential data is generated through differential modulation performed on the modulated symbols, a phase difference between two adjacent modulated symbols of the differential data is not only π/2 or −π/2, but may have more phase difference values. In this case, SC-FDMA symbols of two adjacent differential data symbols of the differential data may be superposed in a same direction. This results in a high PAPR. Therefore, a PAPR of an SC-FDMA symbol generated based on the differential data generated according to the conventional Pi/2-BPSK modulation scheme is high. This affects demodulation performance.

In a possible implementation, the first communication device modulates the to-be-sent bit data to obtain the modulated data. A relationship between the to-be-sent bit data and the modulated data satisfies formula (2). The first communication device performs differential modulation on the modulated data to obtain the second data. A relationship between the modulated data and the second data satisfies formula (5), and the second data is x in formula (5). Formula (2) is used, so that the m^{th} data unit (modulated symbol) d(m) of the modulated data is 1 or −1. In this case, a phase difference between any two modulated symbols is π or 0. Therefore, when differential modulation is performed on the modulated data to obtain the second data, a quantity of values of a phase difference between two adjacent data units (differential data symbols) of the second data can be reduced, thereby reducing a PAPR. Specifically, when formula (2) and formula (5) are used, the phase difference between the two adjacent differential data symbols of the second data can be π/2 or −π/2, and the PAPR can be reduced.

In another possible implementation, the first communication device modulates the to-be-sent bit data to obtain the modulated data. A relationship between the to-be-sent bit data and the modulated data satisfies formula (6). The first communication device performs differential modulation on the modulated data to obtain the second data. A relationship between the modulated data and the second data satisfies formula (1), and the second data is represented as x in formula (1). Formula (6) is used, so that the m^{th} data unit (modulated symbol) d(m) of the modulated data is j or −j. In this case, a phase difference between any two modulated symbols is π or 0. Therefore, when differential modulation is performed on the modulated data to obtain the second data, a quantity of values of a phase difference between two adjacent data units (differential data symbols) of the second data can be reduced, thereby reducing a PAPR. Specifically, when formula (6) and formula (1) are used, the phase difference between the two adjacent differential data symbols of the second data can be π/2 or −π/2, and the PAPR can be reduced.

Optionally, the first communication device may determine an improved BPSK modulation scheme. The first communication device generates second data by using the improved BPSK modulation scheme, where the second data includes at least two differential data symbols, and a phase difference between any two differential data symbols is π or 0. The first communication device modulates to-be-sent bit data to obtain modulated data. A relationship between the to-be-sent bit data and the modulated data satisfies formula (2). The first communication device performs differential modulation on the modulated data to obtain the second data. A relationship between the modulated data and the second data satisfies formula (1), and the second data is represented as x in formula (1). In this way, the second data can still be BPSK modulated data (a phase difference between any two differential data symbols is π or 0), and a PAPR of an SC-FDMA symbol generated based on the second data is low, and is consistent with a PAPR of an SC-FDMA symbol based on BPSK modulated data.

Optionally, the first communication device may determine an improved QPSK modulation scheme. The first communication device generates second data by using the improved QPSK modulation scheme, where the second data includes at least two differential data symbols. The first communication device modulates to-be-sent bit data to obtain modulated data. A relationship between the to-be-sent bit data and the modulated data satisfies formula (3) or satisfies formula (4). The first communication device performs differential modulation on the modulated data to obtain the second data. A relationship between the modulated data and the second data satisfies formula (1), and the second data is represented as x in formula (1). In this way, the second data can still be QPSK modulated data, and a PAPR of an SC-FDMA symbol generated based on the second data is low, and is consistent with a PAPR of an SC-FDMA symbol based on QPSK modulated data.

Optionally, the first communication device may alternatively perform spreading processing on second data to obtain spreading data of the second data, and the first communication device may generate an SC-FDMA symbol based on the spreading data of the second data.

To implement functions in the method provided in this disclosure, the apparatus or the device provided in this disclosure may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular disclosures and design constraints of the technical solutions. In this disclosure, division into modules is an example, and is merely logical function division. There may be another division manner during actual implementation. In addition, functional modules in embodiments of this disclosure may be integrated into one processor, or may exist alone physically, or two or more modules may be integrated into one module. The integrated module may be implemented in a form of hardware, or may be implemented in a form of a software functional module.

FIG. 19 shows a device 1900 according to this disclosure. The device 1900 is configured to implement the data processing method in the foregoing method embodiments. The device may alternatively be a chip system. The device 1900 includes a communication interface 1901. The communication interface may be, for example, a transceiver, an interface, a bus, a circuit, or an apparatus that can implement a receiving and sending function. The communication interface 1901 is configured to communicate with another device by using a transmission medium, so that an apparatus used in the device 1900 may communicate with the another device. The device 1900 further includes at least one processor 1902. The processor 1902 and the communication interface 1901 are configured to implement the method performed by the first communication device and the second communication device in the method embodiments corresponding to FIG. 3 to FIG. 18.

For example, the communication interface 1901 and the processor 1902 are configured to implement the method performed by the first communication device in the method embodiments corresponding to FIG. 3 to FIG. 11. In this example, the device 1900 may be a terminal device, or may be an apparatus in the terminal device, or may be an apparatus that can be used in a matching manner with the terminal device. The communication interface 1901 is configured to obtain first data, where the first data includes at least two differential data symbols or at least two differential spreading data symbols. The processor 1902 is configured to map, based on a mapping relationship between the first data and a time-frequency resource, the first data to the time-frequency resource for transmission. The mapping relationship includes that two adjacent data units in the first data are adjacent in time domain or frequency domain on the time-frequency resource. The data unit is any one of the following: the differential data symbol, the differential spreading data symbol, and a differential spreading data symbol block. For an execution procedure of the communication interface 1901 and the processor 1902 in this example, refer to detailed descriptions of the operation performed by the first communication device in the method embodiments corresponding to FIG. 3 to FIG. 11. Details are not described herein again. In this example, steps performed by the communication interface 1901 and the processor 1902 enable the first data to be sent on a plurality of symbols. In comparison with sending the first data on one symbol, the first communication device may flexibly select, based on different scenarios of a time offset or a frequency offset, a mapping relationship between the first data and the time-frequency resource. Based on the mapping relationship, when the time offset or the frequency offset causes a change in frequency domain channels, frequency domain channels that two adjacent data units in the first data pass through can be close. This helps improve demodulation performance.

For example, the communication interface 1901 and the processor 1902 are configured to implement the method performed by the second communication device in the method embodiments corresponding to FIG. 3 to FIG. 11. In this example, the device 1900 may be a network device, or may be an apparatus in the network device, or may be an apparatus that can be used in a matching manner with the network device. The communication interface 1901 is configured to receive first data on a time-frequency resource, where the first data includes at least two differential data symbols or at least two differential spreading data symbols. The processor 1902 is configured to demodulate the first data based on a mapping relationship. The mapping relationship includes that two adjacent data units in the first data are adjacent in time domain or frequency domain on the time-frequency resource. The data unit is any one of the following: the differential data symbol, the differential spreading data symbol, and a differential spreading data symbol block. For an execution procedure of the communication interface 1901 and the processor 1902 in this example, refer to detailed descriptions of the operation performed by the second communication device in the method embodiments corresponding to FIG. 3 to FIG. 11. Details are not described herein again. In this example, steps performed by the communication interface 1901 and the processor 1902 enable that when the first data is mapped to the time-frequency resource for transmission based on the mapping relationship, a change in channels between two adjacent data units during demodulation by the receiver can be reduced. This helps improve demodulation performance of the receiver when the receiver demodulates the first data based on the mapping relationship.

For example, the communication interface 1901 and the processor 1902 are configured to implement the method performed by the first communication device in the method embodiments corresponding to FIG. 12 to FIG. 15. In this example, the device 1900 may be a terminal device, or may be an apparatus in the terminal device, or may be an apparatus that can be used in a matching manner with the terminal device. The communication interface 1901 is configured to obtain first data, where the first data includes at least two differential data symbols or at least two differential spreading data symbols. The processor 1902 is configured to map, based on a mapping relationship between the first data and a time-frequency resource, the first data to the time-frequency resource for transmission. The time-frequency resource includes/symbols and K subcarriers. The mapping relationship includes: The first data is mapped along the L symbols in a first direction on the 2k^{th} subcarrier, and is mapped along the L symbols in the first direction on the (2p+1)^{th} subcarrier based on a data unit. Alternatively, the mapping relationship includes: The first data is mapped along the K subcarriers in a first direction on the 2l^{th} symbol, and is mapped along the K subcarriers in the first direction on the (2q+1)^{th} symbol based on a data unit. The data unit is a differential data symbol or a differential spreading data symbol. k is an integer that satisfies 0≤2k≤K−1, p is an integer that satisfies 0≤2p+1≤K−1, l is an integer that satisfies 0≤2l≤ L−1, and q is an integer that satisfies 0≤2q+1≤ L−1. L and K are integers greater than 1. For an execution procedure of the communication interface 1901 and the processor 1902 in this example, refer to detailed descriptions of the operation performed by the first communication device in the method embodiments corresponding to FIG. 12 to FIG. 15. Details are not described herein again. In this example, in a scenario in which no time offset or frequency offset exists, steps performed by the communication interface 1901 and the processor 1902 enable the first communication device to map, by using the mapping relationship, two adjacent differential data symbols or differential spreading data symbols in the first data to the time-frequency resource for transmission. The mapping relationship is simple and easier to implement. In addition, in the scenario in which no time offset or frequency offset exists, frequency domain channels that the two adjacent differential data symbols or differential spreading data symbols in the first data pass through can also be close. This helps improve demodulation performance.

For example, the communication interface 1901 and the processor 1902 are configured to implement the method performed by the first communication device in the method embodiments corresponding to FIG. 16 and FIG. 17. In this example, the device 1900 may be a terminal device, or may be an apparatus in the terminal device, or may be an apparatus that can be used in a matching manner with the terminal device. The communication interface 1901 is configured to obtain first data, where the first data includes at least two differential data symbols or at least two differential spreading data symbols. The processor 1902 is configured to map, based on a mapping relationship between the first data and a time-frequency resource, the first data to the time-frequency resource for transmission. The time-frequency resource includes L symbols and K subcarriers. The mapping relationship includes:

The first data is mapped along the L symbols in a first direction between the 2k×k_{block}^{th} subcarrier and the ((2k+1)k_{block}−1)^{th} subcarrier, and is mapped along the L symbols in the first direction between the (2p+1)k_{block}^{th} subcarrier and the (2(p+1)k_{block}−1)^{th} subcarrier based on a data unit. Alternatively,
the first data is mapped along the K subcarriers in a first direction between the 2l×l_{block}^{th} with symbol and the ((2l+1)l_{block}−1)^{th} symbol, and is mapped along the K subcarriers in the first direction between the (2q+1)l_{block}^{th} symbol and the (2(q+1)l_{block}−1)^{th} symbol based on a data unit.

The data unit is a differential spreading data symbol block. The differential spreading data symbol block includes l_{block}×k_{block} differential spreading data symbols. k is an integer that satisfies 0≤ (2k+1) k_{block}−1≤K−1, p is an integer that satisfies 0≤2(p+1)k_{block}−1≤K−1, l is an integer that satisfies 0≤(2l+1)l_{block}−1≤L−1, q is an integer that satisfies 0≤2 (q+1)l_{block}−1≤L−1, block is an integer that satisfies 1≤l_{block}≤ L, and k_{block} is an integer that satisfies 1≤k_{block}≤K. L and K are integers greater than 1.

For an execution procedure of the communication interface 1901 and the processor 1902 in this example, refer to detailed descriptions of the operation performed by the first communication device in the method embodiments corresponding to FIG. 16 and FIG. 17. Details are not described herein again. In this example, in a scenario in which no time offset or frequency offset exists, steps performed by the communication interface 1901 and the processor 1902 enable the first communication device to map, by using the mapping relationship, two adjacent differential spreading data symbol blocks in the first data to the time-frequency resource for transmission. The mapping relationship is simple and easier to implement. In addition, in the scenario in which no time offset or frequency offset exists, frequency domain channels that the two adjacent differential spreading data symbol blocks in the first data pass through can also be close. This helps improve demodulation performance.

For example, the communication interface 1901 and the processor 1902 are configured to implement the method performed by the first communication device in the method embodiment corresponding to FIG. 18. In this example, the device 1900 may be a terminal device, or may be an apparatus in the terminal device, or may be an apparatus that can be used in a matching manner with the terminal device. The communication interface 1901 is configured to obtain second data, where the second data includes at least two differential data symbols. The second data is differential data symbols generated by using a Pi/2-BPSK modulation scheme, and a phase difference between two adjacent differential data symbols is π/2 or −π/2. For an execution procedure of the communication interface 1901 and the processor 1902 in this example, refer to detailed descriptions of the operation performed by the first communication device in the method embodiment corresponding to FIG. 18. Details are not described herein again. In this example, in steps performed by the communication interface 1901 and the processor 1902, the differential data symbol is generated by using an improved Pi/2-BPSK modulation scheme. In comparison with that a phase difference between differential data symbols generated by using a conventional Pi/2-BPSK modulation scheme may have two or more different values, a value of the phase difference between the differential data symbols generated in this disclosure is π/2 or −π/2. This helps demodulate the data.

The device 1900 may further include at least one memory 1903, configured to store program instructions and/or data. In an implementation, the memory 1903 is coupled to the processor 1902. Couplings in this disclosure are indirect couplings or communication connections between apparatuses, units, or modules, and may be electrical, mechanical, or in another form, and are used for information exchange between the apparatuses, the units, and the modules. The processor 1902 may operate cooperatively with the memory 1903. The processor 1902 may execute the program instructions stored in the memory 1903. The at least one memory and the processor are integrated together.

A specific connection medium between the communication interface 1901, the processor 1902, and the memory 1903 is not limited in this disclosure. In this disclosure, in FIG. 19, the memory 1903, the processor 1902, and the communication interface 1901 are connected through a bus 1904. The bus is represented by a bold line in FIG. 19. A manner of connection between other components is merely an example for description, and is not limited thereto. The bus may be classified into an address bus, a data bus, a control bus, and the like. For ease of representation, only one bold line is used for representation in FIG. 19, but this does not mean that there is only one bus or only one type of bus.

In this disclosure, the processor may be a general-purpose processor, a digital signal processor, an disclosure-specific integrated circuit, a field programmable gate array or another programmable logic device, a discrete gate or transistor logic device, or a discrete hardware component, and may implement or execute the methods, steps, and logical block diagrams disclosed in this disclosure. The general-purpose processor may be a microprocessor or any conventional processor or the like. The steps of the methods disclosed with reference to this disclosure may be directly implemented by a hardware processor, or may be implemented by a combination of hardware in the processor and a software module.

In this disclosure, the memory may be a non-volatile memory, for example, a hard disk drive (HDD) or a solid-state drive (SSD), or may be a volatile memory, for example, a random access memory (RAM). The memory is any other medium that can carry or store expected program code in a form of an instruction structure or a data structure and that can be accessed by a computer, but is not limited herein. The memory in this disclosure may alternatively be a circuit or any other apparatus that can implement a storage function, and is configured to store the program instructions and/or the data.

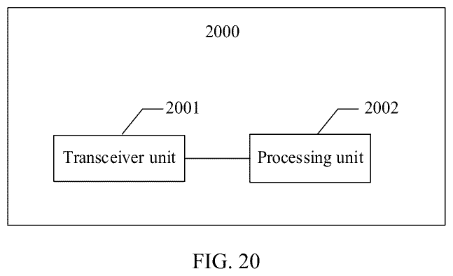

FIG. 20 shows an apparatus 2000 according to this disclosure. In an implementation, the apparatus may include a one-to-one corresponding module for performing the method/operation/step/action described in the method embodiments corresponding to FIG. 3 to FIG. 18. The module may be a hardware circuit, or may be software, or may be implemented by a combination of the hardware circuit and the software. In an implementation, the apparatus may include a transceiver unit 2001 and a processing unit 2002.

For example, the apparatus 2000 may be a first communication device, or may be an apparatus in the first communication device, or may be an apparatus that can be used in a matching manner with the first communication device. The transceiver unit 2001 is configured to obtain first data, where the first data includes at least two differential data symbols or at least two differential spreading data symbols. The processing unit 2002 is configured to map, based on a mapping relationship between the first data and a time-frequency resource, the first data to the time-frequency resource for transmission. The mapping relationship includes that two adjacent data units in the first data are adjacent in time domain or frequency domain on the time-frequency resource. The data unit is any one of the following: the differential data symbol, the differential spreading data symbol, and a differential spreading data symbol block. For an execution procedure of the transceiver unit 2001 and the processing unit 2002 in this example, refer to detailed descriptions of the operation performed by the first communication device in the method embodiments corresponding to FIG. 3 to FIG. 11. Details are not described herein again. In this example, steps performed by the transceiver unit 2001 and the processing unit 2002 enable the first data to be sent on a plurality of symbols. In comparison with sending the first data on one symbol, the first communication device may flexibly select, based on different scenarios of a time offset or a frequency offset, a mapping relationship between the first data and the time-frequency resource. Based on the mapping relationship, when the time offset or the frequency offset causes a change in frequency domain channels, frequency domain channels that two adjacent data units in the first data pass through can be close. This helps improve demodulation performance.

For example, the apparatus 2000 may be a second communication device, or may be an apparatus in the second communication device, or may be an apparatus that can be used in a matching manner with the second communication device. The transceiver unit 2001 is configured to receive first data on a time-frequency resource, where the first data includes at least two differential data symbols or at least two differential spreading data symbols. The processing unit 2002 is configured to demodulate the first data based on a mapping relationship. The mapping relationship includes that two adjacent data units in the first data are adjacent in time domain or frequency domain on the time-frequency resource. The data unit is any one of the following: the differential data symbol, the differential spreading data symbol, and a differential spreading data symbol block. For an execution procedure of the transceiver unit 2001 and the processing unit 2002 in this example, refer to detailed descriptions of the operation performed by the second communication device in the method embodiments corresponding to FIG. 3 to FIG. 11. Details are not described herein again. In this example, steps performed by the transceiver unit 2001 and the processing unit 2002 enable that when the first data is mapped to the time-frequency resource for transmission based on the mapping relationship, a change in channels between two adjacent data units during demodulation by the receiver can be reduced. This helps improve demodulation performance of the receiver when the receiver demodulates the first data based on the mapping relationship.

For example, the apparatus 2000 may be a first communication device, or may be an apparatus in the first communication device, or may be an apparatus that can be used in a matching manner with the first communication device. The transceiver unit 2001 is configured to obtain first data, where the first data includes at least two differential data symbols or at least two differential spreading data symbols. The processing unit 2002 is configured to map, based on a mapping relationship between the first data and a time-frequency resource, the first data to the time-frequency resource for transmission. The time-frequency resource includes L symbols and K subcarriers. The mapping relationship includes: The first data is mapped along the L symbols in a first direction on the 2k^{th} subcarrier, and is mapped along the L symbols in the first direction on the (2p+1)^{th} subcarrier based on a data unit. Alternatively, the mapping relationship includes: The first data is mapped along the K subcarriers in a first direction on the 2l^{th} symbol, and is mapped along the K subcarriers in the first direction on the (2q+1)^{th} symbol based on a data unit. The data unit is a differential data symbol or a differential spreading data symbol. k is an integer that satisfies 0≤2k≤K−1, p is an integer that satisfies 0≤2p+1≤K−1, l is an integer that satisfies 0≤2l≤L−1, and q is an integer that satisfies 0≤2q+1≤ L−1. L and K are integers greater than 1. For an execution procedure of the transceiver unit 2001 and the processing unit 2002 in this example, refer to detailed descriptions of the operation performed by the first communication device in the method embodiments corresponding to FIG. 12 to FIG. 15. Details are not described herein again. In this example, in a scenario in which no time offset or frequency offset exists, steps performed by the transceiver unit 2001 and the processing unit 2002 enable the first communication device to map, by using the mapping relationship, two adjacent differential data symbols or differential spreading data symbols in the first data to the time-frequency resource for transmission. The mapping relationship is simple and easier to implement. In addition, in the scenario in which no time offset or frequency offset exists, frequency domain channels that the two adjacent differential data symbols or differential spreading data symbols in the first data pass through can also be close. This helps improve demodulation performance.

For example, the apparatus 2000 may be a first communication device, or may be an apparatus in the first communication device, or may be an apparatus that can be used in a matching manner with the first communication device. The transceiver unit 2001 is configured to obtain first data, where the first data includes at least two differential data symbols or at least two differential spreading data symbols. The processing unit 2002 is configured to map, based on a mapping relationship between the first data and a time-frequency resource, the first data to the time-frequency resource for transmission. The time-frequency resource includes L symbols and K subcarriers. The mapping relationship includes:

The first data is mapped along the L symbols in a first direction between the 2k×k_{block}^{th} subcarrier and the ((2k+1)k_{block}−1)^{th} subcarrier, and is mapped along the L block symbols in the first direction between the (2p+1)k_{block}^{th} subcarrier and the (2(p+1)k_{block}−1)^{th} subcarrier based on a data unit. Alternatively, the first data is mapped along the K subcarriers in a first direction between the 2l×l_{block}^{th} symbol and the ((2l+1)l_{block}−1)^{th} symbol, and is mapped along the K subcarriers in the first direction between the (2q+1)l_{block}^{th} symbol and the (2(q+1)l_{block}−1)^{th} symbol based on a data unit.

The data unit is a differential spreading data symbol block. The differential spreading data symbol block includes l_{block}×k_{block} differential spreading data symbols. k is an integer that satisfies 0≤ (2k+1)k_{block}−1≤K−1, p is an integer that satisfies 0≤2 (p+1)k_{block}−1≤K−1, l is an integer that satisfies 0≤(2l+1)l_{block}−1≤L−1, q is an integer that satisfies 0≤2 (q+1)l_{block}−1≤L−1, l_{block} is an integer that satisfies 1≤l_{block}≤L, and k_{block} is an integer that satisfies 1≤k_{block}≤K. L and K are integers greater than 1.

For an execution procedure of the transceiver unit 2001 and the processing unit 2002 in this example, refer to detailed descriptions of the operation performed by the first communication device in the method embodiments corresponding to FIG. 16 and FIG. 17. Details are not described herein again. In this example, in a scenario in which no time offset or frequency offset exists, steps performed by the transceiver unit 2001 and the processing unit 2002 enable the first communication device to map, by using the mapping relationship, two adjacent differential spreading data symbol blocks in the first data to the time-frequency resource for transmission. The mapping relationship is simple and easier to implement. In addition, in the scenario in which no time offset or frequency offset exists, frequency domain channels that the two adjacent differential spreading data symbol blocks in the first data pass through can also be close. This helps improve demodulation performance.

For example, the apparatus 2000 may be a first communication device, or may be an apparatus in the first communication device, or may be an apparatus that can be used in a matching manner with the first communication device. The transceiver unit 2001 is configured to obtain second data, where the second data includes at least two differential data symbols. The second data is differential data symbols generated by using a Pi/2-BPSK modulation scheme, and a phase difference between two adjacent differential data symbols is π/2 or −π/2. For an execution procedure of the transceiver unit 2001 and the processing unit 2002 in this example, refer to detailed descriptions of the operation performed by the first communication device in the method embodiments corresponding to FIG. 18. Details are not described herein again. In this example, in steps performed by the transceiver unit 2001 and the processing unit 2002, the differential data symbol is generated by using an improved Pi/2-BPSK modulation scheme. In comparison with that a phase difference between differential data symbols generated by using a conventional Pi/2-BPSK modulation scheme may have two or more different values, a value of the phase difference between the differential data symbols generated in this disclosure is π/2 or −π/2. This helps demodulate the data.

This disclosure provides a communication system. The communication system includes a first communication device and a second communication device that are configured to perform the method in the embodiments corresponding to FIG. 3 to FIG. 18.

This disclosure provides a communication apparatus. The communication apparatus includes an input/output interface and a logic circuit. The input/output interface is configured to input or output data. For example, in the embodiment in FIG. 3, data input by an input/output interface may be first data. The logic circuit processes the data according to the method performed by the first communication device in the embodiments corresponding to FIG. 3 to FIG. 18, to obtain processed data. For example, in the embodiment in FIG. 3, processed data may be data that is obtained by mapping the first data to a time-frequency resource and that is for transmission.

This disclosure provides another communication apparatus. The communication apparatus includes an input/output interface and a logic circuit. The input/output interface is configured to input or output data. The logic circuit processes the data according to the method performed by the second communication device in the embodiments corresponding to FIG. 3 to FIG. 18, to obtain processed data.

This disclosure provides a computer-readable storage medium. The computer-readable storage medium stores a program or instructions. When the program or the instructions are run on a computer, the computer is enabled to perform the data processing method in the embodiments corresponding to FIG. 3 to FIG. 18.

This disclosure provides a computer program product. The computer program product includes instructions. When the instructions are run on a computer, the computer is enabled to perform the data processing method in the embodiments corresponding to FIG. 3 to FIG. 18.

This disclosure provides a chip or a chip system. The chip or the chip system includes at least one processor and an interface. The interface and the at least one processor are interconnected through a line. The at least one processor is configured to run a computer program or instructions, to perform the data processing method in the embodiments corresponding to FIG. 3 to FIG. 18.

The interface in the chip may be an input/output interface, a pin, a circuit, or the like.

The chip system may be SoC, a baseband chip, or the like. The baseband chip may include a processor, a channel encoder, a digital signal processor, a modem, an interface module, and the like.

In an implementation, the chip or the chip system described above in this disclosure further includes at least one memory, and the at least one memory stores instructions. The memory may be a storage unit inside the chip, for example, a register or a cache, or may be a storage unit (for example, a read-only memory or a random access memory) of the chip.

All or some of the technical solutions provided in this disclosure may be implemented by using software, hardware, firmware, or any combination thereof. When the software is used to implement the technical solutions, all or some of the technical solutions may be implemented in a form of a computer program product. The computer program product includes one or more computer instructions. When the computer program instructions are loaded and executed on a computer, all or some of procedures or functions according to this disclosure are generated. The computer may be a general-purpose computer, a dedicated computer, a computer network, a network device, a terminal device, or another programmable apparatus. The computer instructions may be stored in a computer-readable storage medium, or may be transmitted from a computer-readable storage medium to another computer-readable storage medium. For example, the computer instructions may be transmitted from a website, a computer, a server, or a data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a digital video disc (DVD)), a semiconductor medium, or the like.

In this disclosure, on the premise that there is no logical conflict, the embodiments may be mutually referenced. For example, methods and/or terms in the method embodiments may be mutually referenced, functions and/or terms in the apparatus embodiments may be mutually referenced, and functions and/or terms in the apparatus embodiments and the method embodiments may be mutually referenced.

A person skilled in the art could make various modifications and variations to this disclosure without departing from the scope of this disclosure. This disclosure is intended to cover those modifications and variations of this disclosure provided that they fall within the scope of protection defined by the following claims and their equivalent technologies.

What is claimed is:

1. A method applied by a transmitting end, where the method comprises:
obtaining first data, where the first data comprises at least two differential data symbols or at least two differential spreading data symbols; and
mapping, based on a mapping relationship between the first data and a time-frequency resource, the first data to the time-frequency resource for transmission, where the mapping relationship comprises: two adjacent data units in the first data are adjacent in time domain or frequency domain on the time-frequency resource; and a data unit is any one of the following: the differential data symbol, the differential spreading data symbol, or a differential spreading data symbol block.

2. The method according to claim 1, where the data unit is the differential data symbol or the differential spreading data symbol, the time-frequency resource comprises L symbols and K subcarriers, and the mapping relationship comprises one or more of:
the first data is mapped along the L symbols in a first direction on the 2k^{th} subcarrier, and is mapped along the L symbols in a second direction on the (2p+1)^{th} subcarrier based on the data unit; or
the first data is mapped along the K subcarriers in a first direction on the 2l^{th} symbol, and is mapped along the K subcarriers in a second direction on the (2q+1)^{th} symbol based on the data unit,
where the first direction is opposite to the second direction, k is an integer that satisfies 0≤2k≤K−1, p is an integer that satisfies 0≤2p+1≤K−1, l is an integer that satisfies 0≤2l≤L−1, q is an integer that satisfies 0≤2q+1≤L−1, and L and K are integers greater than 1.

3. The method according to claim 1, where the data unit is the differential spreading data symbol block, the differential spreading data symbol block comprises l_{block}×k_{block} differential spreading data symbols, the time-frequency resource comprises L symbols and K subcarriers, and the mapping relationship comprises one or more of:
the first data is mapped along the L symbols in a first direction between the 2k×k_{block}^{th} subcarrier and the ((2k+1)k_{block}−1)^{th} subcarrier, and is mapped along the L symbols in a second direction between the (2p+1)k_{block}^{th} subcarrier and the (2(p+1)k_{block}−1)^{th} subcarrier based on the data unit; or
the first data is mapped along the K subcarriers in a first direction between the 2l×l_{block} symbol and the ((2l+1)l_{block}−1)^{th} symbol, and is mapped along the K subcarriers in a second direction between the (2p+1)l_{block}^{th} symbol and the (2(q+1)l_{block}−1)^{th} symbol based on the data unit,
where the first direction is opposite to the second direction, k is an integer that satisfies 0≤ (2k+1)k_{block}−1≤K−1, p is an integer that satisfies 0≤2 (p+1)k_{block}−1≤K−1, 1 is an integer that satisfies 0≤ (2l+1)l_{block}−1≤L−1, q is an integer that satisfies 0≤2 (q+1)l_{block}−1≤L−1, l_{block} is an integer that satisfies 1≤l_{block}≤L, k_{block} is an integer that satisfies 1≤k_{block}≤K, and L and K are integers greater than 1.

4. The method according to claim 1, further comprising:
outputting an initial value of the first data, where the initial value of the first data is predefined, or transmitting the initial value of the first data when the first data is mapped to the time-frequency resource for transmission.

5. The method according to claim 1, further comprising one of:
(i) mapping the first data to the time-frequency resource, and generating data of an orthogonal frequency division multiplexing symbol based on data on the time-frequency resource; and
sending the data of the orthogonal frequency division multiplexing symbol to a second communication device; or
(ii) mapping the first data to the time-frequency resource, and performing Fourier transform to obtain corresponding Fourier transform output data;
generating data of a single carrier frequency division multiple access symbol based on the Fourier transform output data; and
sending the data of the single carrier frequency division multiple access symbol to a receiving end.

6. The method according to claim 1, where the first data comprises differential data symbols generated by using a Pi/2 binary phase shift keying (Pi/2−BPSK) modulation scheme, and a phase difference between two adjacent differential data symbols is π/2 or −π/2.

7. The method according to claim 6, where a phase difference between any two modulated symbols is π or 0, and the differential data symbol is obtained based on differential modulation of the modulated symbol.

8. The method according to claim 6, where the modulated symbol is obtained by modulating to-be-sent bit data according to the Pi/2-BPSK modulation scheme, and a relationship between the to-be-sent bit data and the modulated symbol satisfies:
$$d ( m ) = 1 - 2 b ( m ) ,$$
where b(m) represents the m^{th} piece of to-be-sent bit data in at least two pieces of to-be-sent bit data, and d(m) represents the m^{th} modulated symbol in at least two modulated symbols; and
a relationship between the modulated symbol and the differential data symbol satisfies:
$$x ( m ) = {e}^{j \frac{π ( m m o d 2 )}{2}} x ( m - 1 ) * d ( m ) ,$$
Where x(m) represents the m^{th} differential data symbol in at least two differential data symbols, x(m−1) represents the (m−1)^{th} differential data symbol in the at least two differential data symbols, and d(m) represents the m^{th} modulated symbol in the at least two modulated symbols; or
a relationship between the to-be-sent bit data and the modulated symbol satisfies:
$$d ( m ) = j [ 1 - 2 b ( m ) ] ,$$
where b(m) represents the m^{th} piece of to-be-sent bit data in at least two pieces of to-be-sent bit data, d(m) represents the m^{th} modulated symbol in at least two modulated symbols, and j represents an imaginary symbol; and
a relationship between the modulated symbol and the differential data symbol satisfies:
$$x ( m ) = x ( m - 1 ) * d ( m ) ,$$
where x(m) represents the m^{th} differential data symbol in at least two differential data symbols, x(m−1) represents the (m−1)^{th} differential data symbol in the at least two differential data symbols, and d(m) represents the m^{th} modulated symbol in the at least two modulated symbols.

9. A method, where the method is applicable to a transmitting end and the method comprises:
obtaining first data, where the first data comprises at least two differential data symbols or at least two differential spreading data symbols; and
mapping, based on a mapping relationship between the first data and a time-frequency resource, the first data to the time-frequency resource for transmission,
where the time-frequency resource comprises L symbols and K subcarriers, and the mapping relationship comprises one or more of:
the first data is mapped along the L symbols in a first direction on the 2k^{th} subcarrier, and is mapped along the L symbols in the first direction on the (2p+1)^{th} subcarrier based on a data unit; or
the first data is mapped along the K subcarriers in a first direction on the 2l^{th} symbol, and is mapped along the K subcarriers in the first direction on the (2q+1)^{th} symbol based on a data unit,
where the data unit is the differential data symbol or the differential spreading data symbol, k is an integer that satisfies 0≤2k≤K−1, p is an integer that satisfies 0≤2p+1≤K−1, l is an integer that satisfies 0≤2l≤ L−1, q is an integer that satisfies 0≤2q+1≤L−1, and L and K are integers greater than 1.

10. An apparatus, comprising an input/output interface and a logic circuit, the input/output interface is configured to:
obtain first data, where the first data comprises at least two differential data symbols or at least two differential spreading data symbols; and
the logic circuit is configured to map, based on a mapping relationship between the first data and a time-frequency resource, the first data to the time-frequency resource for transmission,
where the mapping relationship comprises: two adjacent data units in the first data are adjacent in time domain or frequency domain on the time-frequency resource; and
a data unit is any one of: the differential data symbol, the differential spreading data symbol, or a differential spreading data symbol block.

11. The apparatus according to claim 10, where the data unit is the differential data symbol or the differential spreading data symbol, the time-frequency resource comprises L symbols and K subcarriers, and the mapping relationship comprises one or more of:
the first data is mapped along the L symbols in a first direction on the 2k^{th} subcarrier, and is mapped along the L symbols in a second direction on the (2p+1)^{th} subcarrier based on the data unit; or
the first data is mapped along the K subcarriers in a first direction on the 2l^{th} symbol, and is mapped along the K subcarriers in a second direction on the (2q+1)^{th} symbol based on the data unit, where
the first direction is opposite to the second direction, k is an integer that satisfies 0≤2k≤K−1, p is an integer that satisfies 0≤2p+1≤K−1, 7 is an integer that satisfies 0≤2l≤L−1, q is an integer that satisfies 0≤2q+1≤ L−1, and L and K are integers greater than 1.

12. The apparatus according to claim 10, where the data unit is the differential spreading data symbol block, the differential spreading data symbol block comprises l_{block}×k_{block} differential spreading data symbols, the time-frequency resource comprises L symbols and K subcarriers, and the mapping relationship comprises one or more of:
the first data is mapped along the L symbols in a first direction between the 2k×k_{block}^{th} subcarrier and the ((2k+1)k_{block}−1)^{th} subcarrier, and is mapped along the L symbols in a second direction between the (2p+1)k_{block}^{th} subcarrier and the (2(p+1)k_{block}−1)^{th} subcarrier based on the data unit; or
the first data is mapped along the K subcarriers in a first direction between the 2l×l_{block}^{th} symbol and the ((2l+1)(k_{block}−1)^{th} symbol, and is mapped along the K subcarriers in a second direction between the (2q+1)l_{block}^{th} symbol and the (2(q+1)l_{block}−1)^{th} symbol based on the data unit, where
the first direction is opposite to the second direction, k is an integer that satisfies 0≤(2k+1)k_{block}−1≤K−1, p is an integer that satisfies 0≤2 (p+1)k_{block}−1≤K−1, 1 is an integer that satisfies 0≤ (2l+1)l_{block}−1≤L−1, q is an integer that satisfies 0≤2 (q+1)l_{block}−1≤L−1, l_{block} is an integer that satisfies 1≤l_{block}≤L, k_{block} is an integer that satisfies 1≤k_{block}≤K, and L and K are integers greater than 1.

13. The apparatus according to claim 10, where the input/output interface is further configured to:
output an initial value of the first data, where the initial value of the first data is predefined, or transmit the initial value of the first data when the first data is mapped to the time-frequency resource for transmission.

14. The apparatus according to claim 10, where the logic circuit is further configured to:
(i) map the first data to the time-frequency resource, and generate data of an orthogonal frequency division multiplexing symbol based on data on the time-frequency resource; and
the input/output interface is further configured to send the data of the orthogonal frequency division multiplexing symbol to a receiving end; or
(ii) the logic circuit is further configured to map the first data to the time-frequency resource, perform Fourier transform to obtain corresponding Fourier transform output data, and generate data of a single carrier frequency division multiple access symbol based on the Fourier transform output data; and
the input/output interface is further configured to send the data of the single carrier frequency division multiple access symbol to a receiving end.

15. The apparatus according to claim 10, where the first data comprises differential data symbols generated by using a Pi/2 binary phase shift keying (Pi/2-BPSK) modulation scheme, and a phase difference between two adjacent differential data symbols is π/2 or −π/2.

16. The apparatus according to claim 15, where a phase difference between any two modulated symbols is π or 0, and the differential data symbol is obtained based on differential modulation of the modulated symbol.

17. The apparatus according to claim 15, where the modulated symbol is obtained by modulating to-be-sent bit data according to the Pi/2-BPSK modulation scheme, and a relationship between the to-be-sent bit data and the modulated symbol satisfies:
$$d ( m ) = 1 - 2 b ( m ) ,$$
where
b(m) represents the m^{th} piece of to-be-sent bit data in at least two pieces of to-be-sent bit data, and d(m) represents the m^{th} modulated symbol in at least two modulated symbols; and
a relationship between the modulated symbol and the differential data symbol satisfies:
$$x ( m ) = {e}^{j \frac{π ( m m o d 2 )}{2}} x ( m - 1 ) * d ( m ) ,$$
where
x(m) represents the m^{th} differential data symbol in at least two differential data symbols, x(m−1) represents the (m−1)^{th} differential data symbol in the at least two differential data symbols, and d(m) represents the m^{th} modulated symbol in the at least two modulated symbols; or
a relationship between the to-be-sent bit data and the modulated symbol satisfies:
$$d ( m ) = j [ 1 - 2 b ( m ) ] ,$$
where
b(m) represents the m^{th} piece of to-be-sent bit data in at least two pieces of to-be-sent bit data, d(m) represents the m^{th} modulated symbol in at least two modulated symbols, and j represents an imaginary symbol; and
a relationship between the modulated symbol and the differential data symbol satisfies:
$$x ( m ) = x ( m - 1 ) * d ( m ) ,$$
x(m) represents the m^{th} differential data symbol in at least two differential data symbols, x(m−1) represents the (m−1)^{th} differential data symbol in the at least two differential data symbols, and d(m) represents the m^{th} modulated symbol in the at least two modulated symbols.
